(19) United States
(12) Patent Application Publication
(10) Pub. No.: US 2012/0263771 A1
(43) Pub. Date: Oct. 18, 2012

(54) FIBER WITH MICROBIAL REMOVAL, MICRO-BIOCIDAL, OR STATIC GROWTH CAPABILITY

(75) Inventors: Robert E. Carlson, Minnetonka, MN (US); Kurt E. Heikkila, Marine on the St. Croix, MN (US); Karen Schlichtmann Schmidt, Chaska, MN (US); Robert M. Carlson, Duluth, MN (US)

(73) Assignee: RECEPTORS LLC, Chaska, MN (US)

(21) Appl. No.: 13/428,413

(22) Filed: Mar. 23, 2012

Related U.S. Application Data
(60) Provisional application No. 61/467,604, filed on Mar. 25, 2011.

(51) Int. Cl. A01N 25/34; A01P 15/00; A01N 37/12; A01N 25/08; A01N 43/40

(52) U.S. Cl. 424/405; 424/402; 514/357; 514/563

(57) ABSTRACT

The fiber structures in the form of a fiber (or fiber mass), woven or nonwoven fabric, fiber absorbent layers, mats or bats or other collection of fiber can be modified to be microbiocidal, bacteriostatic, obtain immobilized, microbes, etc. The disclosed fiber has the unique ability to capture and hold microbes or microbial generating units within the fiber mass.

### CROSS REFERENCE TO RELATED APPLICATIONS

This application claims priority to U.S. Provisional Patent Application No. 61/467,604, filed Mar. 25, 2011, the contents of which are herein incorporated by reference in their entirety.

### FIELD

Microbial control with a fiber based product that can be in the form of a mass of fiber, bat, or wipe often in the form of a nonwoven.

### BACKGROUND

Microbial contamination can be the cause of problems in many fields of activity. Unwanted microbial populations can be a health hazard, cause problems in pharmaceutical and food production and in general can cause waste due to the harmful effects of such bioactive microbial contamination on sensitive compositions and materials. Many liquids gasses and surfaces can contain a microbial residue of sufficiently high numbers to contaminate a sensitive product or process. Elimination or removal of such numbers is a desired end.

In the past, fiber, woven and nonwoven fabric and similar materials have been used as a cotton ball, sponge or wipe and have been combined with solvent or a small molecule (often Quat) chemistry to obtain microbial removal, micro-biocidal or static growth characteristics. Also antibody structures have also been used in fiber or fabric for such purposes. These all have useful physical attributes however a substantial need exists in obtaining fiber based materials that have substantially improved microbial capture, microbial micro-biocidal or microbial static growth characteristics. A strong need exists in the art to obtain removal of harmful microbial population from surfaces but with little or no risk in recontamination or redeposition from the wipe. In this mode, immobilization of the microbe onto the fiber is needed.

### SUMMARY

The fiber structures can be in the form of a fiber (or fiber mass), woven or nonwoven fabric, fiber absorbent layers, mats or bats or other collection of fiber. The fiber can be modified to be microbiocidal, bacteriostatic, obtain immobilized microbes, etc. The disclosed fiber has the unique ability to capture and hold microbes or microbial generating units within the fiber mass. The fiber structures can render microbes substantially innocuous through micro-biocidal or static growth properties. The fiber has defined fiber characteristics, comprises unique capture chemistry and can capture microbes and bind them to the fiber.

For the purpose of this patent disclosure the term “capture/removal chemistry” indicates a polyamine compound as defined below or a building block structure or both in a capture unit as defined below. In the hierarchy of structures, a building block can contain a number of structures (see below).

The fiber can be used as a fiber, a collection of fiber such as a fiber bat or felt or other micro collection of fiber, or as a woven or nonwoven fabric. These structures can have applications in a variety of applications in which the end use fiber article can come into contact with a microbial population on a surface. Typically, the wipe is used to contact the microbe in a wet environment. A large variety of applications for such articles are disclosed.

The modified fiber has microbial removal, micro-biocidal or static growth capabilities. The fiber can be used as a fiber, a collection of fibers, or a woven or nonwoven fabric. The fiber in its varying embodiments can comprise a capture mechanism on the fiber. The capture mechanism can be fiber loaded (mg-gm⁻¹ of fiber) or surface loaded (mg-cm⁻² of fabric). The capture mechanism comprises at least a microbial capture agent or capture chemistry or binding composition cooperating with the fiber to capture organisms. In use the fiber, in its varying embodiments, can be contacted with a surface comprising a microbial population. As the fiber and capture mechanism interacts with the population on the surface, the capture chemistry and the fiber characteristics bonds to the microbial population obtains capture of a substantial quantity of the microbe population and achieves substantial removal of the population from the surface.

In conjunction with its removal characteristics, the fiber can also obtain a captured microbe and achieve either micro-biocidal mode, static growth characteristic or both. The microbe can be rendered into an essentially non-active or “killed” state or can retain at least some minimum metabolic functionality. In any event the cooperation between the capture mechanism and the fiber can prevent the microbe, either in a static growth or a micro-biocidal mode, from being an infective agent it is once associated with the fiber.

For the purpose of this patent disclosure term “surface” refers to a wet or dry surface without substantial soil but with potentially harmful surface organism contamination. Such surface can appear clean in many environments but can have a harmful population of organisms. The CFU numbers sufficient for risk depends on the organism. The surface contamination is sufficient such that an individual patient, worker or other personnel, coming in contact with a surface, can acquire sufficient organism contamination for a challenge to product quality or human health. Such surfaces are commonly exposed in a household, medical or hospital, food service or production facility.

For the purpose of this patent disclosure, the term “capable of removing a challenge population of target organisms to a degree that the surface is substantially non-infective” indicates that the surface when contacted with the fiber, nonwoven or wipe is rendered substantially harmless due to a reduction in the microbial population measured in CFU's by a VCT technique. Microbial population reductions are typically measured using the industry standard Total Viable Count Technique (VCT). The VCT technique is typically reported in colony forming units (CFU) that for fluids is (CFU-cm⁻³) or surface (CFU-cm²). In performing the VCT procedure, a suspect or control or treated area is then wiped with a test wipe soaked in water, a test solution or nutrient broth. The wipe collects a representative number of microorganisms from a predetermined area of the target surface. Typically the test solution, from the fiber, bat or wipe, depending on the degree of contamination, can be plated out using serial decimal dilutions, using (e.g.) the Miles and Misra Total Viable Count technique and incubated at 37° C. overnight (inverted). The number of colony forming units (CFU), each typically representing a viable bacterial individual, can then be counted and used to determine the degree of bacterial removal from the surface attained by the fiber or wipe. In the foods manufacture and preparation industry, a food contact surface is considered to be fully sanitized (rendered non-infective) when the microbial populations are reduced by at least 99.999% (i.e) at least five orders of magnitude 5 log₁₀. In other words, with an initial population of approximately 10⁵ CFU, less than one CFU remain. Certain microorganisms are more infective than others. As little as one CFU can be infective for certain organisms while substantially larger CFU numbers can pose new risk. The fiber compositions can reduce microbial surface populations by at least some minimal removal or at least 50%, at least 90% or at least 99%, (i.e.) a 2 log₁₀, 99.9% (i.e.) a 3 log₁₀, or 99.99%, (i.e.) a 4 log₁₀ reduction and achieve at least some degree of microbial prophylaxis. The wipes are capable of a full sanitizing regimen with a 5 log₁₀ reduction which is typically sufficient for rendering a surface non-infective.

For the purpose of this patent disclosure the term a “wet environment” indicates that the microbes contact the capture chemistry of the fiber wherein the fiber and the microbe are both in contact with moisture from the wipe, the environment or elsewhere.

TABLE 1
Minimum Effective Doses (MID) for a Range of Organisms

| Organism | MID |
|---|---|
| Salmonella spp. | 11⁴-10⁷ |
| Salmonella Typhi | 10 |
| E. Coli 0157:H7 | 10-10² |
| Vibrio Cholerae | 10³ |
| Gardia Intestinalis | 10-10² |
| Cryptosporidium parvius | 10-10² |
| Entamoeba histolytica | 10-10² |
| Hepatitis A virus | 1-10 Pfu |

As used herein, the term “organism, microbe or microorganism” refers to any bacteria, fungus, virus, or other infective structure including prions, etc. or toxins thereof having a surface chemistry that can bind with the removal chemistry of the fiber. As used herein, the term “ligand” refers to a binding site on a microbial surface such as a polysaccharide, protein, peptide or polypeptide. As used herein, the term “peptide” or “polypeptide” refers to a compound including two or more amino acid residues joined by amide bond(s). As used herein “capture unit” can comprise removal unit and other chemistry such a tether or linker, and a “removal unit” can comprise the capture/removal chemistry or a portion of the capture/removal chemistry within a building block or tether (see table 2 and related text for details of the removal agent). As used herein a “removal unit” can comprise the capture chemistry or a portion of the capture chemistry with a building block or tether. As used herein, the term “support” refers to a macroscopic fiber, fiber collection, or a woven or non-woven fabric. As used herein, the term “non-woven support” refers to a non-woven fabric or array of fiber, typically cellulosic, mixed cellulosic/synthetic or synthetic (e.g. polyolefin, polyester) non-woven fiber. As used herein, the term “building block” refers to a molecular scale structure of organic units that can contain a “removal unit” for the purpose of microbial removal. As used herein the phrase “capture agent” refers to at least an immobilized removal unit that binds a ligand at a predetermined loading of removal unit.

The term “about” modifying, for example, the quantity of an ingredient in a composition, concentration, volume, process temperature, process time, yield, flow rate, pressure, and like values, and ranges thereof, employed in describing the embodiments of the disclosure, refers to variation in the numerical quantity that can occur, for example, through typical measuring and handling procedures used for making compounds, compositions, concentrates or use formulations; through inadvertent error in these procedures; through differences in the manufacture, source, or purity of starting materials or ingredients used to carry out the methods, and like proximate considerations. The term “about” also encompasses amounts that differ due to aging of a formulation with a particular initial concentration or mixture, and amounts that differ due to mixing or processing a formulation with a particular initial concentration or mixture. Whether modified by the term “about” the claims appended hereto include equivalents to these quantities. “Optional” or “optionally” means that the subsequently described event or circumstance may but need not occur, and that the description includes instances where the event or circumstance occurs and instances in which it does not. For example, “A optionally B” means that B may but need not be present, and the description includes situations where A includes B and situations where A does not include B. “Includes” or “including” or like terms means “includes, but not limited to.” The claims may suitably comprise, consist of, or consist essentially of, any of the disclosed or recited elements. Thus, the claimed technology illustratively disclosed herein can be suitably practiced in the absence of any element which is not specifically disclosed herein. As used herein, the term “building block” refers to a molecular component of a capture agent including portions that can be envisioned as or that include one or more of a combination of linkers, one or more supports, and one or more removal units. In an embodiment, the building block includes a linker, a support, and one or more removal units. In an embodiment, the linker includes a moiety suitable for reversibly immobilizing the building block, for example, on a support, surface or lawn. The building block interacts with the ligand. As used herein, the term “linker” refers to a portion of or functional group on a building block that can be employed to or that does (e.g., reversibly) couple the building block to a support, for example, through covalent link, ionic interaction, electrostatic interaction, or hydrophobic interaction. As used herein, the term “amine” indicates a compound with a —NH₂ or a —NH— group, a “polyamine” refers to an amine (as described at page 30 below) (e.g. ethylene diamine, diethylene triamine, triethylene tetramine, tetra ethylene pentamine, etc.) containing repeating units of a secondary amine (—NH) with alternating units of a C₂₋₁₀ alkylene group. Both the nitrogen atoms and the carbons of the polyamine can be modified or substituted.

### BRIEF DESCRIPTION OF FIGURES

FIGS. 1, 2 and 3 shows the results of E. coli removal/release testing.

FIG. 4 shows the apparatus built for the wiping testing.

### DESCRIPTION

A fiber, fiber collection, fiber bat, fabric (woven or non-woven) is disclosed having a fiber surface having capture/removal chemistry that can trap, immobilize, adsorb or absorb an organism onto or into the fiber from the surface and render the surface safe and free of contamination. The organism is removed from a surface in sufficient numbers to reduce the infective nature of the surface. In one embodiment the fiber uses a pendant amine group. In a second embodiment the fiber uses a pendant organic building block containing receptor group. In a third embodiment the fiber uses a combination of the amine and the organic receptor. This combination of groups provides excellent microbial removal.

Any of a variety of different types of organisms, microorganisms or microbes may generally be bound and removed from a surface. Target organisms include pathogens and non-pathogens including bacteria, fungi, viruses, mold, yeast, and toxins thereof, etc. For example, bacteria of a variety of different shapes, cell arrangements, and compositions can be treated. Most bacteria, for instance, have one of five basic cell shapes, i.e., (1) round or cocci, (2) rod or bacilli, (3) spiral or spirilli, (4) comma or vibrios, and (5) filaments. Likewise, examples of possible cell arrangements include diplococci (e.g., pair), streptococci (e.g., chain), and staphylococci (e.g., bunched). Diplococci, for example, are known to cause pneumonia. Streptococci are often associated with “strep throat.” Staphylococci are familiar to many because of their role in “staph infections” and some types of food poisoning. Bacteria also vary somewhat in size, but generally average about 0.4 mil (0.01 mm) per bacteria. Although bacteria generally contain cell membranes (i.e., walls) made from lipid bi-layers of liposaccharides, the composition of a type of bacteria may be more specifically classified using a stain Gram+ or Gram− (G+ or G−) reaction (a staining method to classify bacteria). For example, gram-positive bacteria retain crystal violet stain in the presence of alcohol or acetone and include, for instance, the genera Actinomyces, Bacillus, Bifidobacterium, Cellulomonas, Clostridium, Corynebacterium, Micrococcus, Mycobacterium, Nocardia, Staphylococcus, Streptococcus and Streptomyces. Some of the Gram-positive bacteria notably those of the genera Corynebacterium, Mycobacterium and Nocardia retain dyes even in the presence of acid. These are known as Acid-Fast bacteria. Gram-negative bacteria do not retain crystal violet stain in the presence of alcohol or acetone, and include, for instance, the genera Acetobacter, Agrobacterium, Alcaligenes, Bordetella, Brucella, Campylobacter, Caulobacter, Enterobacter, Erwinia, Escherichia, Helicobacterium, Legionella, Nesseria, Nitrobact, Pasteurelia, Pseudomonas, Rhizobium, Rickettsia, Salmonella, Shigella, Thiobacilus, Veiellonealla, Vibrio, Xanthomonas and Yersinia.

Gram-negative cell membranes include lipopolysaccharides as a main component, and additionally include phospholipids, proteins, lipoproteins, and small amounts of peptidoglycans. The lipopolysaccharide component has a core region to which are attached repeating units of polysaccharide moieties or side chains. The chemical composition of these side chains, both with respect to composition and arrangement of the different sugars, determines the nature of the somatic or O antigen determinants. Such determinants, in turn, are useful in serologically classifying many gram-negative species. For example, some types of gram-negative bacteria that belong to quite different species and have strong serological cross-reactivity, nevertheless possess chemically similar carbohydrate moieties as part of their lipopolysaccharide side chains, which generally have about 30 repeating units. The cell membranes of gram-positive bacteria include peptidoglycans, polysaccharides, and/or teichoic acids. The peptidoglycans (also called “murein”) are heteropolymers of glycan strands and are cross-linked through short peptides. The bases of the murein are chains of alternating residues of N-acetylglucosamine and N-acetyl muramic acid, which are β-1,4-linked. These chains are cross-linked by short polypeptide chains containing both L- and D-amino acids

Despite sharing common features, the arrangement and composition of the surfaces of gram-positive and gram-negative bacteria nevertheless differ. For example, gram-negative bacteria have an outer membrane coated with lipopolysaccharide (LPS). The LPS lends a net-negative charge to the surface of gram-negative bacteria and contributes to its pathogenesis. Gram-positive bacteria, on the other hand, are coated with thick peptidoglycan (or murein) sheet-like layers. The sheets are formed from alternating N-acetylglucosamine and N-acetylmuramic acid molecules. Teichoic acids are also found in gram-positive bacteria and may be linked to the N-acetylmuramic acid. While gram-negative bacteria also have peptidoglycan, the layer on gram-positive bacteria is much thicker. The peptidoglycan layer of gram-negative bacteria is also located underneath the LPS layer, making it less accessible from the surface.

In addition to bacteria, other microbes of interest include molds and yeasts (e.g., Candida albicans), which belong to the Fungi kingdom. Zygomycota, for example, is a class of fungi that includes black bread mold and other molds that exhibit a symbiotic relationship with plants and animals. These molds are capable of fusing and forming tough “zygospores.” Ascomycota is another class of fungi, which includes yeasts, powdery mildews, black and blue-green molds, and some species that cause diseases such as Dutch elm disease, apple scab, and ergot. The life cycle of these fungi combines both sexual and asexual reproduction, and the hyphae are subdivided into porous walls that allow for passage of the nuclei and cytoplasm. Deuteromycota is another class of fungi that includes a miscellaneous collection of fungi that do not fit easily into the aforementioned classes or the Basidiomycota class (which includes most mushrooms, pore fungi, and puffball fungi). Deuteromycetes include the species that create cheese and penicillin, but also includes disease-causing members such as those that lead to athlete's foot and ringworm.

Organisms that cause common human diseases include viruses associated with common cold, the flu, chickenpox and cold sores. Serious diseases such as Ebola and AIDS are also caused by viruses. Many viruses cause little or no disease and are said to be “benign”. The more harmful viruses are described as virulent. Viruses cause different diseases depending on the types of cell that they infect. Some viruses can cause life-long or chronic infections where the viruses continue to reproduce in the body despite the host's defense mechanisms. This is common in hepatitis B virus and hepatitis C virus infections. People chronically infected with a virus are known as carriers. They serve as important reservoirs of the virus. If there is a high proportion of a carrier in a given population, a disease is said to be endemic.

There are many ways in which viruses spread from host to host but each species of virus uses only one or two. Many viruses that infect plants are carried by organisms; such organisms are called vectors. Some viruses that infect animals and humans are also spread by vectors, usually blood-sucking insects. However, direct animal-to-animal, person-to-person or animal-to-person transmission is more common. Some virus infections, (norovirus and rotavirus), are spread by contaminated food and water, hands and communal objects and by intimate contact with another infected person, while others are airborne (influenza virus). Viruses such as HIV, hepatitis B and hepatitis C are often transmitted by human contact or contaminated hypodermic needles. The spreading mechanism for each different kind of virus must be known to treat the correct surface to stop viral spread and to prevent infections and epidemics.

The fiber can contain a removal unit in the form of an amine or a capture agent similar to the units in U.S. Pat. No. 7,469,076 or 7,504,364, which are expressly incorporated by reference herein, for the teaching of binding units on a surface. The fiber can contain one or more removal units, optionally at an end of the building block, tether, link or other organic structure(s). Such a building block can be envisioned as including a support moiety located at or forming that end of the building block. The removal units can be coupled to the support moiety. Such a building block can also include a tether moiety.

“Tether” is a group or moiety that can provide spacing or distance between any component and any other component or distance between any component (e.g., the removal unit) and the support or scaffold to which the building block is immobilized. A tether moiety can have any of a variety of characteristics or properties including flexibility, rigidity or stiffness, ability to bond to another tether moiety, and the like. The tether moiety can include the linker group. The support moiety can be envisioned as forming all or part of the tether moiety.

The tether can include groups, defined below, suitable for coupling one building block to another or one tether to another. Such coupling can provide, for example, rigidity or positioning to a building block with a flexible tether. Such coupling can maintain, for example, two building blocks in proximity to one another. The coupling can be reversible, which can allow the coupled building blocks to “change partners” and couple to no or a different building block.

The capture agent is part of a building block. The building block is a chemical moiety or group of moieties that are bound to one or more surfaces of a filter constituent or filter media. The filter constituent or filter media is thus a substrate, and the building blocks containing the capture agent is bound to the substrate. The building block includes, in some embodiments, one or more elements in addition to the capture agent. For example the building block includes, in some embodiments, a tether or a linker. The capture agent includes at least one removal unit, that is, a chemical moiety that is the chemical means for interaction with an organism that results in removal, or capture, of the organism from the mobile fluid. In some embodiments, the substrate is functionalized directly with the removal unit, such that the removal unit represents the entirety of the building block. Thus, in some non-limiting examples, building blocks bound to the surface of a substrate are schematically represented in the following manner:
SUBSTRATE - - - BUILDING BLOCK
SUBSTRATE - - - TETHER - - - LINKER - - - CAPTURE AGENT
SUBSTRATE - - - LINKER - - - TETHER - - - CAPTURE AGENT
SUBSTRATE - - - LINKER - - - CAPTURE AGENT
SUBSTRATE - - - TETHER - - - CAPTURE AGENT
SUBSTRATE - - - TETHER - - - LINKER - - - REMOVAL UNIT
SUBSTRATE - - - LINKER - - - TETHER - - - REMOVAL UNIT
SUBSTRATE - - - LINKER - - - REMOVAL UNIT
SUBSTRATE - - - TETHER - - - REMOVAL UNIT
SUBSTRATE - - - TETHER - - - REMOVAL UNITS (more than 1)
SUBSTRATE - - - LINKER - - - REMOVAL UNITS
SUBSTRATE - - - REMOVAL UNITS
SUBSTRATE - - - BUILDING BLOCK [REMOVAL UNITS]
SUBSTRATE - - - BUILDING BLOCK - - - TETHER - - - BUILDING BLOCK
SUBSTRATE - - - BUILDING BLOCK - - - LINKER - - - BUILDING BLOCK
SUBSTRATE - - - LINKER - - - BUILDING BLOCK
SUBSTRATE - - - TETHER - - - BUILDING BLOCK

This technology relates to a method of making an capture agent or a candidate capture agent. In an embodiment, this method includes preparing region on a support or non-woven support, the region including one of or a plurality of building blocks immobilized on the support. In an embodiment, at least one of the building blocks optionally includes a tether moiety. The method can include forming on a fiber, fiber mat or bat, on a woven support or non-woven support, a building block on the fiber. In an embodiment, at least one of the building blocks in the fiber includes a tether.

The method can include mixing a building block(s) and employing the mixture in or on the support. Coupling a building block to the support can employ covalent bonding or noncovalent interactions. Suitable noncovalent interactions include interactions between ions, hydrogen bonding, van der Waals interactions, and the like. In an embodiment, the support can be functionalized with a removal unit that can engage in a binding association with a microbial surface or covalent bonding or noncovalent bonding interactions.

Forming the capture/removal unit chemistry on the fiber yields a loading of the removal units on the fiber sufficient to interact with capture or remove microbial structures that come into close association with the removal unit and fiber.

The method can immobilize building blocks on a support or non-woven support using known methods for coupling (immobilizing) compounds of the types employed as removal units. Coupling to the support can employ covalent bonding or noncovalent interactions. Suitable noncovalent interactions include interactions between ions, hydrogen bonding, van der Waals interactions, and the like. In an embodiment, the support can be functionalized with moieties that can engage in reversible covalent bonding, moieties that can engage in noncovalent interactions, a mixture of these moieties, or the like.

In an embodiment, the support can be functionalized with moieties that can engage in covalent bonding, e.g., reversible covalent bonding. This technology can employ any of a variety of the numerous known functional groups, reagents, and reactions for forming reversible covalent bonds. Suitable reagents for forming reversible covalent bonds include those described in Green, T W; Wuts, PGM (1999), Protective Groups in Organic Synthesis Third Edition, Wiley-Interscience, New York, 779 pp. For example, the support can include functional groups such as a carbonyl group, a carboxyl group, a silane group, boric acid or ester, an amine group (e.g., a primary, secondary, or tertiary amine, a hydroxylamine, a hydrazine, or the like), a thiol group, an alcohol group (e.g., primary, secondary, or tertiary alcohol), a diol group (e.g., a 1,2 diol or a 1,3 diol), a phenol group, a catechol group, or the like. These functional groups can form groups with reversible covalent bonds, such as ether (e.g., alkyl ether, silyl ether, thioether, or the like), ester (e.g., alkyl ester, phenol ester, cyclic ester, thioester, or the like), acetal (e.g., cyclic acetal), ketal (e.g., cyclic ketal), silyl derivative (e.g., silyl ether), boronate (e.g., cyclic boronate), amide, hydrazide, imine, carbamate, or the like. Such a functional group can be referred to as a covalent bonding moiety, e.g., a first covalent bonding moiety.

A carbonyl group on the support and an amine group on a building block can form an imine or Schiff's base. The same is true of an amine group on the support and a carbonyl group on a building block. A carbonyl group on the support and an alcohol group on a building block can form an acetal or ketal. The same is true of an alcohol group on the support and a carbonyl group on a building block. A thiol (e.g., a first thiol) on the support and a thiol (e.g., a second thiol) on the building block can form a disulfide.

A carboxyl group on the support and an alcohol group on a building block can form an ester. The same is true of an alcohol group on the support and a carboxyl group on a building block. Any of a variety of alcohols and carboxylic acids can form esters that provide covalent bonding that can be reversed. For example, reversible ester linkages can be formed from alcohols such as phenols with electron withdrawing groups on the aryl ring, other alcohols with electron withdrawing groups acting on the hydroxyl-bearing carbon, other alcohols, or the like; and/or carboxyl groups such as those with electron withdrawing groups acting on the acyl carbon (e.g., nitrobenzylic acid, R—CF₂—COOH, R—CCl₂—COOH, and the like), other carboxylic acids, or the like.

The support can be functionalized with moieties that can engage in noncovalent interactions. For example, the support can include functional groups such as a charged moiety, an ionic group, a group that can hydrogen bond, or a group that can engage in van der Waals or other hydrophobic interactions. Such functional groups can include cationic groups, anionic groups, lipophilic groups, amphiphilic groups, and the like.

In an embodiment, the support includes a lipophilic moiety (e.g., a first lipophilic moiety). Suitable lipophilic moieties include branched or straight chain C₆₋₃₆ alkyl, C₈₋₂₄ alkyl, C₁₂₋₂₄ alkyl, C₁₂₋₁₈ alkyl, or the like; C₆₋₃₆ alkenyl, C₈₋₇₄ alkenyl, C₁₂₋₂₄alkenyl, C₁₂₋₁₈ alkenyl, or the like, with, for example, 1 to 4 double bonds; C₆₋₃₆ alkynyl, C₈₋₂₄ alkynyl, C₁₂₋₂₄ alkynyl, C₁₂₋₁₈ alkynyl, or the like, with, for example, 1 to 4 triple bonds; chains with 1-4 double or triple bonds; chains including aryl or substituted aryl moieties (e.g., phenyl or naphthyl moieties at the end or middle of a chain); polyaromatic hydrocarbon moieties; cycloalkane or substituted alkane moieties with numbers of carbons as described for chains; combinations or mixtures thereof; or the like. The alkyl, alkenyl, or alkynyl group can include branching; within chain functionality like an ether group; terminal functionality like alcohol, amide, carboxylate or the like; or the like. A lipophilic moiety like a quaternary ammonium lipophilic moiety can also include a positive charge.

The building blocks are used for making or forming candidate capture agents. Building blocks can be designed, made, and selected to provide a variety of structural characteristics among a small number of compounds. A building block can provide one or more structural characteristics such as positive charge, negative charge, acid, base, electron acceptor, electron donor, hydrogen bond donor, hydrogen bond acceptor, free electron pair, π electrons, charge polarization, hydrophilicity, hydrophobicity, and the like. A building block can be bulky or it can be small.

“Building block” can be visualized as including several components, such as one or more linkers, one or more removal units, and/or one or more tethers. The linker can be covalently coupled to the support. The linker can be coupled to a support through one or more of covalent, electrostatic, hydrogen bonding, van der Waals, or like interactions. The removal unit can be covalently coupled to the support. The tether can be covalently coupled to the linker and to the support. In an embodiment, a building block includes a support, a linker, a removal unit, and a tether. In an embodiment, a building block includes a linker, a tether, and two removal units.

A description of general and specific features and functions of a variety of building blocks and their synthesis can be found in U.S. patent application Ser. No. 10/244,727, filed Sep. 16, 2002, Ser. No. 10/813,568, filed Mar. 29, 2004, and Application No. PCT/US03/05328, filed Feb. 19, 2003, each entitled “ARTIFICIAL RECEPTORS, BUILDING BLOCKS, AND METHODS”; U.S. patent application Ser. Nos. 10/812,850 and 10/813,612, and application No. PCT/US2004/009649, each filed Mar. 29, 2004 and each entitled “ARTIFICIAL RECEPTORS INCLUDING REVERSIBLY IMMOBILIZED BUILDING BLOCKS, THE BUILDING BLOCKS, AND METHODS”; and U.S. Provisional Patent Application No. 60/499,965, filed Sep. 3, 2003, and 60/526,699, filed Dec. 2, 2003, each entitled BUILDING BLOCKS FOR ARTIFICIAL RECEPTORS; the disclosures of which are incorporated herein by reference. These patent documents include, in particular, a detailed written description of: function, structure, and configuration of building blocks, removal units, synthesis of building blocks, specific embodiments of building blocks, specific embodiments of removal units, and sets of building blocks.

This embodiment of a removal unit can be selected for functional groups that provide for coupling to the removal moiety and for coupling to or being the tether and/or linking moieties. The removal unit can interact with the ligand as part of the capture agent including multiple reaction sites with orthogonal and reliable functional groups and with controlled stereochemistry. Suitable functional groups with orthogonal and reliable chemistries include, for example, carboxyl, amine, hydroxyl, phenol, carbonyl, and thiol groups, which can be individually protected, deprotected, and derivatized. In an embodiment, two, three, or four functional groups with orthogonal and reliable chemistries are used. In an embodiment, the removal unit has three functional groups. In such an embodiment, the three functional groups can be independently selected, for example, from carboxyl, amine, hydroxyl, phenol, carbonyl, or thiol group and can include alkyl, substituted alkyl cycloalkyl, heterocyclic, substituted heterocyclic, aryl alkyl, aryl, heteroaryl, heteroaryl alkyl, and like moieties.

A general structure for a removal with three functional groups can be represented by Formula 1ₐ.

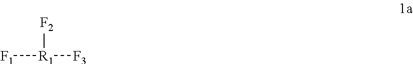

A general with four functional groups can be represented by Formula 1_{b}.

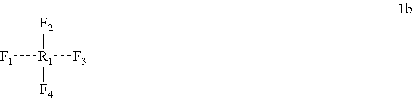

In these general structures: R₁ can be a 1-12, a 1-6, or a 1-4 carbon alkyl, substituted alkyl, cycloalkyl, heterocyclic, substituted heterocyclic, aryl alkyl, aryl, heteroaryl, heteroaryl alkyl, or like group; and F₁, F₂, F₃, or F₄ can independently be a carboxyl, amine, hydroxyl, phenol, carbonyl, or thiol group. F₁, F₂, F₃, or F₄ can independently be a 1-12, a 1-6, a 1-4 carbon alkyl, substituted alkyl, cycloalkyl, heterocyclic, substituted heterocyclic, aryl alkyl, aryl, heteroaryl, heteroaryl alkyl, or inorganic group substituted with carboxyl, amine, hydroxyl, phenol, carbonyl, or thiol group. F₃ and/or F₄ can be absent.

A variety of compounds fit the formulas and text describing the support including amino acids, and naturally occurring or synthetic compounds including, for example, oxygen and sulfur functional groups. The compounds can be racemic, optically active, or achiral. For example, the compounds can be natural or synthetic amino acids, .α-hydroxy acids, thioic acids, and the like.

All of the naturally occurring and many synthetic amino acids are commercially available. Further, forms of these amino acids derivatized or protected to be suitable for reactions for coupling to removal unit(s) and/or linkers can be purchased or made by known methods (see, e.g., Green, T W; Wuts, PGM (1999), Protective Groups in Organic Synthesis Third Edition, Wiley-Interscience, New York, 779 pp.; Bodanszky, M.; Bodanszky, A. (1994), The Practice of Peptide Synthesis Second Edition, Springer-Verlag, New York, 217 pp.).

In an embodiment, a building block can include a tether moiety. The tether moiety can provide spacing or distance between the removal unit and the support or scaffold to which the building block is immobilized. A tether moiety can have any of a variety of characteristics or properties including flexibility, rigidity or stiffness, ability to bond to another tether moiety, and the like. The tether moiety can include the linker.

Tether moieties can include a polyethylene glycol, a polyamide, a linear polymer, a peptide, a polypeptide, an oligosaccharide, a polysaccharide, a semifunctionalized oligo- or polyglycine. In an embodiment, the tether is or includes a polymer of up to 2000 carbon atoms (e.g., up to 48 carbon atoms). Such a polymer can be naturally occurring or synthetic. Suitable polymers include a polyether or like polymer, such as a PEG, a polyethyleneimine, polyacrylate (e.g., substituted polyacrylates), salt thereof, a mixture or combination thereof, or the like. Suitable PEGs include PEG 1500 up to PEG 20,000, for example, PEG 1450, PEG 3350, PEG 4500, PEG 8000, PEG 20,000, and the like.

Suitable tether moieties can include one or more branched or straight chain C₆₋₃₆ alkyl, C₈₋₂₄ alkyl, C₁₂₋₂₄ alkyl, C₁₂₋₁₈ alkyl, or the like; C₆₋₃₆ alkenyl, C₈₋₂₄, alkenyl, C₁₂₋₂₄ alkenyl, C₁₂₋₁₈ alkenyl, or the like, with, for example, 1 to 4 double bonds; C₆₋₃₆ alkynyl, C₈₋₂₄ alkynyl, C₁₂₋₂₄ alkynyl, C₁₂₋₁₈ alkynyl, or the like, with, for example, 1 to 4 triple bonds; chains with 1-4 double or triple bonds; chains including aryl or substituted aryl moieties (e.g., phenyl or naphthyl moieties at the end or middle of a chain); polyaromatic hydrocarbon moieties; cycloalkane or substituted alkane moieties with numbers of carbons as described for chains; combinations or mixtures thereof; or the like. The alkyl, alkenyl, or alkynyl group can include branching; within chain functionality like an ether group; terminal functionality like alcohol, amide, carboxylate or the like; or the like. In an embodiment, the lipophilic moiety includes or is a 12-carbon aliphatic moiety.

Rigid tether moieties can include conformationally restricted groups such as imines, aromatics, and polyaromatics. Rigid tether moieties can include one or more branched or straight chain C₆₋₃₆ alkenyl, C₈₋₂₄ alkenyl, C₃₂₋₂₄ alkenyl, C₁₂₋₁₈ alkenyl, or the like, with, for example, 2 to 8 double bonds; C₆₋₃₆ alkynyl, C₈₋₇₄ alkynyl, C₁₂₋₂₄ alkynyl, C₁₂₋₁₈ alkynyl, or the like, with, for example, 1 to 8 triple bonds; chains with 3-8 double or triple bonds; chains including aryl or substituted aryl moieties (e.g., phenyl or naphthyl moieties at the end or middle of a chain); polyaromatic hydrocarbon moieties; and the like. The alkenyl or alkynyl group can include branching; within chain functionality like an ether group; terminal functionality like alcohol, amide, carboxylate or the like; or the like. Rigid tether moieties can include a steroid moiety, such as cholesterol, a corrin or another porphyrin, a polynuclear aromatic moiety, a polar polymer fixed with metal ions, or the like.

In an embodiment, a rigid tether moiety can include more than one tether moiety. For example, a rigid tether moiety can include a plurality of hydrophobic chains, such as those described in the paragraph above and in the paragraph below. The hydrophobic chains if held in sufficient proximity on the support or scaffold will, in a hydrophobic solvent, form a grouping sufficiently rigid to hold one or more sets of removal units in place. In another embodiment, a rigid tether moiety can include a plurality of otherwise flexible tether moieties crosslinked to one another. The crosslinking can include, for example, covalent bonding, electrostatic interactions, hydrogen bonding, or hydrophobic interactions. Groups for forming such interactions are disclosed herein.

Flexible tether moieties can include one or more branched or straight chain C₆₋₃₆ alkyl, C₈₋₂₄ alkyl, C₁₂₋₂₄ alkyl, C₁₂₋₁₈ alkyl, or the like; C₆₋₃₆ alkenyl, C₈₋₂₄ alkenyl, C.sub.12-24 alkenyl, C₁₂₋₁₈ alkenyl, or the like, with, for example, 1 to 2 double bonds; C₆₋₃₆ alkynyl, C₈₋₂₄ alkynyl, alkynyl, C₁₂₋₁₈ alkynyl, or the like, with, for example, 1 to 2 triple bonds; chains with 1-2 double or triple bonds; chains including 1 to 2 aryl or substituted aryl moieties (e.g., phenyl or naphthyl moieties at the end or middle of a chain); cycloalkane or substituted alkane moieties with numbers of carbons as described for chains; combinations or mixtures thereof; or the like. The alkyl, alkenyl, or alkynyl group can include branching; within chain functionality like an ether group; terminal functionality like alcohol, amide, carboxylate or the like; or the like. In an embodiment, the lipophilic moiety includes or is a 12-carbon aliphatic moiety.

In an embodiment, the tether forms or can be visualized as forming a covalent bond with an alcohol, phenol, thiol, amine, carbonyl, or like group on the support. Between the bond to the support and the group participating in or formed by the interaction with the support or lawn, the linker can include an alkyl, substituted alkyl, cycloalkyl, heterocyclic, substituted heterocyclic, aryl alkyl, aryl, heteroaryl, heteroaryl alkyl, ethoxy or propoxy oligomer, a glycoside, or like moiety.

Suitable tethers can include, for example: the functional group participating in or formed by the bond to the support, the functional group or groups participating in or formed by the interaction with the support or lawn, and a tether backbone moiety. The tether backbone moiety can include about 8 to about 200 carbon or heteroatoms, about 12 to about 150 carbon or heteroatoms, about 16 to about 100 carbon or heteroatoms, about 16 to about 50 carbon or heteroatoms, or the like. The tether backbone can include an alkyl, substituted alkyl, cycloalkyl, heterocyclic, substituted heterocyclic, aryl alkyl, aryl, heteroaryl, heteroaryl alkyl, ethoxy or propoxy oligomer, a glycoside, mixtures thereof, or like moiety. Suitable tethers have structures such as (CH₂)ₙCOOH, with n=12-24, n=17-24, or n=16-18.

The tether can interact with the ligand as part of the capture agent. The tether can also provide bulk, distance from the support, hydrophobicity, hydrophilicity, and like structural characteristics to the building block. In an embodiment, the tether forms a covalent bond with a functional group on the support. In an embodiment, the tether also includes a functional group that can couple to the tether or to the support or lawn, e.g., through covalent bonding or noncovalent interactions.

In an embodiment, the tether includes one or more moieties for forming a reversible covalent bond, a hydrogen bond, or an ionic interaction, e.g., with another tether moiety. For example, the linker can include about 1 to about 20 reversible bond/interaction moieties or about 2 to about 10 reversible bond/interaction moieties.

In an embodiment, the tether includes one or more moieties that can engage in reversible covalent bonding. Suitable groups for reversible covalent bonding include those described hereinabove. Such groups for reversible covalent bonds can be part of links between tether moieties. The tether-tether links can include, for example, imine, acetal, ketal, disulfide, ester, or like linkages. Such functional groups can engage in reversible covalent bonding. Such a functional group can be referred to as a covalent bonding moiety.

In an embodiment, the tether can be functionalized with moieties that can engage in noncovalent interactions. For example, the tether can include functional groups such as an ionic group, a group that can hydrogen bond, or a group that can engage in van der Waals or other hydrophobic interactions. Such functional groups can include cationic groups, anionic groups, lipophilic groups, amphiphilic groups, and the like.

In an embodiment, the present methods and compositions can employ a tether including a charged moiety. Suitable charged moieties include positively charged moieties and negatively charged moieties. Suitable positively charged moieties include protonated amines, quaternaryammonium moieties, sulfonium, sulfoxonium, phosphonium, ferrocene, and the like. Suitable negatively charged moieties (e.g., at neutral pH in aqueous compositions) include carboxylates, phenols substituted with strongly electron withdrawing groups (e.g., tetrachlorophenols), phosphates, phosphonates, phosphinates, sulphates, sulphonates, thiocarboxylates, and hydroxamic acids.

In an embodiment, the present methods and compositions can employ a tether including a group that can hydrogen bond, either as donor or acceptor (e.g., a second hydrogen bonding group). For example, the tether can include one or more carboxyl groups, amine groups, hydroxyl groups, carbonyl groups, or the like. Ionic groups can also participate in hydrogen bonding.

In an embodiment the removal unit can be polyamine or a 1-12, a 1-6, or a 1-4 carbon alkyl, substituted alkyl, cycloalkyl, heterocyclic, substituted heterocyclic, aryl alkyl, aryl, heteroaryl, heteroaryl alkyl, or like group. The removal unit can be substituted with a group that includes or imparts positive charge, negative charge, acid, base, electron acceptor, electron donor, hydrogen bond donor, hydrogen bond acceptor, free electron pair, it electrons, charge polarization, hydrophilicity, hydrophobicity, and the like.

Removal units with a positive charge (e.g., at neutral pH in aqueous compositions) include protonated amines, quaternary ammonium moieties, sulfonium, sulfoxonium, phosphonium, ferrocene, and the like. Suitable amines include alkyl amines, alkyl diamines, heteroalkyl amines, aryl amines, heteroaryl amines, aryl alkyl amines, pyridines, heterocyclic amines (saturated or unsaturated, the nitrogen in the ring or not), amidines, hydrazines, and the like. Alkyl amines generally have 1 to 12 carbons, e.g., 1-8, and rings can have 3-12 carbons, e.g., 3-8. Suitable alkyl amines include that of formula B9. Suitable heterocyclic or alkyl heterocyclic amines include that of formula A9. Suitable pyridines include those of formulas A5 and B5. Any of the amines can be employed as a quaternary ammonium compound. Additional suitable quaternary ammonium moieties include dimethyl alkyl quaternary ammonium moieties, dimethyl ethyl alkyl quaternary ammonium moieties, dimethyl alkyl quaternary ammonium moieties, aryl alkyl quaternary ammonium moieties, pyridinium quaternary ammonium moieties, and the like.

Removal units with a negative charge (e.g., at neutral pH in aqueous compositions) include carboxylates, phenols substituted with strongly electron withdrawing groups (e.g., substituted tetrachlorophenols), phosphates, phosphonates, phosphinates, sulphates, sulphonates, thiocarboxylates, and hydroxamic acids. Suitable carboxylates include alkyl carboxylates, aryl carboxylates, and aryl alkyl carboxylates. Suitable phosphates include phosphate mono-, di-, and tri-esters, and phosphate mono-, di-, and tri-amides. Suitable phosphonates include phosphonate mono- and di-esters, and phosphonate mono- and di-amides (e.g., phosphonamides). Suitable phosphinates include phosphinate esters and amides.

Removal units with a negative charge and a positive charge (at neutral pH in aqueous compositions) include sulfoxides, betaines, and amine oxides.

Acidic removal units can include carboxylates, phosphates, sulphates, and phenols. Suitable acidic carboxylates include thiocarboxylates. Suitable acidic phosphates include the phosphates listed hereinabove.

Formulas A1-A9 and B1-B9 are shown in Table 2 and are referred to below.

TABLE 2

| | |
|---|---|
| CH₃—CH₂— | A1 |
| (CH₃)₂—CH—CH₂— | A2 |
| 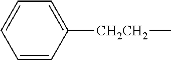 | A3 |
| 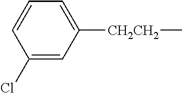 | A3a |
| 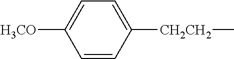 | A4 |
| 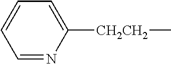 | A5 |
| —CH₂—CH₂—OCH₃ | A6 |
| —CH₂—CH₂—OH | A7 |
| —CH₂—CH₂—NH—C(O)—CH₃ | A8 |
| 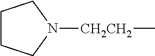 | A9 |
| CH₃— | B1 |
| 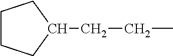 | B2 |
| 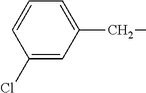 | B3 |
| 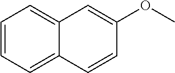 | B3a |
| 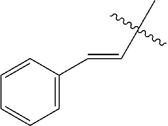 | B4 |
| 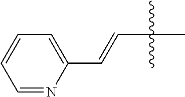 | B5 |
| CH₃—S—CH₂— | B6 |
| CH₃CH(OH)CH₂— | B7 |
| —CH₂CH₂C(O)—NH₂ | B8 |
| (CH₃)₂—N—CH₂CH₂CH₂— | B9 |

Basic reacting removal units include amines. Suitable basic amines include alkyl amines, aryl amines, aryl alkyl amines, pyridines, heterocyclic amines (saturated or unsaturated, the nitrogen in the ring or not), amidines, and any additional amines listed hereinabove. Suitable alkyl amines include that of formula B9. Suitable heterocyclic or alkyl heterocyclic amines include that of formula A9. Suitable pyridines include those of formulas A5 and B5.

Removal units including a hydrogen bond donor include amines, amides, carboxyls, protonated phosphates, protonated phosphonates, protonated phosphinates, protonated sulphates, protonated sulphinates, alcohols, and thiols. Suitable amines include alkyl amines, aryl amines, aryl alkyl amines, pyridines, heterocyclic amines (saturated or unsaturated, the nitrogen in the ring or not), amidines, ureas, and any other amines listed hereinabove. Suitable alkyl amines include that of formula B9. Suitable heterocyclic or alkyl heterocyclic amines include that of formula A9. Suitable pyridines include those of formulas A5 and B5. Suitable protonated carboxylates, protonated phosphates include those listed hereinabove. Suitable amides include those of formulas A8 and B8. Suitable alcohols include primary alcohols, secondary alcohols, tertiary alcohols, and aromatic alcohols (e.g., phenols). Suitable alcohols include those of formulas A7 (a primary alcohol) and B7 (a secondary alcohol).

Removal units including a hydrogen bond acceptor or one or more free electron pairs include amines, amides, carboxylates, carboxyl groups, phosphates, phosphonates, phosphinates, sulphates, sulphonates, alcohols, ethers, thiols, and thioethers. Suitable amines include alkyl amines, aryl amines, aryl alkyl amines, pyridines, heterocyclic amines (saturated or unsaturated, the nitrogen in the ring or not), amidines, ureas, and amines as listed hereinabove. Suitable alkyl amines include that of formula B9. Suitable heterocyclic or alkyl heterocyclic amines include that of formula A9. Suitable pyridines include those of formulas A5 and B5. Suitable carboxylates include those listed hereinabove. Suitable amides include those of formulas A8 and B8. Suitable phosphates, phosphonates and phosphinates include those listed hereinabove. Suitable alcohols include primary alcohols, secondary alcohols, tertiary alcohols, aromatic alcohols, and those listed hereinabove. Suitable alcohols include those of formulas A7 (a primary alcohol) and B7 (a secondary alcohol). Suitable ethers include alkyl ethers, aryl alkyl ethers. Suitable alkyl ethers include that of formula A6. Suitable aryl alkyl ethers include that of formula A4. Suitable thioethers include that of formula B6.

Removal units including uncharged polar or hydrophilic groups include amides, alcohols, ethers, thiols, thioethers, esters, thio esters, boranes, borates, and metal complexes. Suitable amides include those of formulas A8 and B8. Suitable alcohols include primary alcohols, secondary alcohols, tertiary alcohols, aromatic alcohols, and those listed hereinabove. Suitable alcohols include those of formulas A7 (a primary alcohol) and B7 (a secondary alcohol). Suitable ethers include those listed hereinabove. Suitable ethers include that of formula A6. Suitable aryl alkyl ethers include that of formula A4.

Removal units including uncharged hydrophobic groups include alkyl (substituted and unsubstituted), alkene (conjugated and unconjugated), alkyne (conjugated and unconjugated), aromatic. Suitable alkyl groups include lower alkyl, substituted alkyl, cycloalkyl, aryl alkyl, and heteroaryl alkyl. Suitable lower alkyl groups include those of formulas A1, A3, A3a, and B1. Suitable aryl alkyl groups include those of formulas A3, A3a, A4, B3, B3a, and B4. Suitable alkyl cycloalkyl groups include that of formula B2. Suitable alkene groups include lower alkene and aryl alkene. Suitable aryl alkene groups include that of formula B4. Suitable aromatic groups include unsubstituted aryl, heteroaryl, substituted aryl, aryl alkyl, heteroaryl alkyl, alkyl substituted aryl, and polyaromatic hydrocarbons. Suitable aryl alkyl groups include those of formulas A3, A3a and B4. Suitable alkyl heteroaryl groups include those of formulas A5 and B5.

Spacer (e.g., small) removal units include hydrogen, methyl, ethyl, and the like. Bulky removal units include 7 or more carbon or hetero atoms.

These A and B removal units can be called derivatives of, according to a standard reference: A1, ethylamine; A2, isobutylamine; A3, phenethylamine; A4, 4-methoxyphenethylamine; A5, 2-(2-aminoethyl)pyridine; A6, 2-methoxyethylamine; A7, ethanolamine; A8, N-acetylethylenediamine; A9, 1-(2-aminoethyl)pyrrolidine; B1, acetic acid, B2, cyclopentylpropionic acid; B3, 3-chlorophenylacetic acid; B4, cinnamic acid; B5, 3-pyridinepropionic acid; B6, (methylthio)acetic acid; B7, 3-hydroxybutyric acid; B8, succinamic acid; and B9,4-(dimethylamino)butyric acid.

In an embodiment, the removal units include one or more of the structures represented by formulas A1, A2, A3, A3a, A4, A5, A6, A7, A8, and/or A9 (the A removal units) and/or B1, B2, B3, B3a, B4, B5, B6, B7, B8, and/or B9 (the B removal units). In an embodiment, each building block includes an A removal unit and a B removal unit. In an embodiment, a group of 81 such building blocks includes each of the 81 unique combinations of an A removal unit and a B removal unit. In an embodiment, the A removal units are linked to a support at a pendant position. In an embodiment, the B removal units are linked to a support at an equatorial position. In an embodiment, the A removal units are linked to a support at a pendant position and the B removal units are linked to the support at an equatorial position.

Although not limiting, it is believed that the A and B removal units represent the assortment of functional groups and geometric configurations employed by polypeptide receptors. Although not limiting, it is believed that the A removal units represent six advantageous functional groups or configurations and that the addition of functional groups to several of the aryl groups increases the range of possible binding interactions. Although not limiting, it is believed that the B removal units represent six advantageous functional groups, but in different configurations than employed for the A removal units. Although not limiting, it is further believed that this increases the range of binding interactions and further extends the range of functional groups and configurations that is explored by molecular configurations of the building blocks.

In an embodiment, the building blocks including the A and B removal units can be visualized as occupying a binding space defined by lipophilicity/hydrophilicity and volume. A volume can be calculated (using known methods) for each building block including the various A and B removal units. A measure of lipophilicity/hydrophilicity (log P) can be calculated (using known methods) for each building block including the various A and B removal units. Negative values of logP show affinity for water over nonpolar organic solvent and indicate a hydrophilic nature. A plot of volume versus log P can then show the distribution of the building blocks through a binding space defined by size and lipophilicity/hydrophilicity.

Reagents that form many of the removal units are commercially available. For example, reagents for forming removal units A1, A2, A3, A3a, A4, A5, A6, A7, A8, A9 B1, B2, B3, B3a, B4, B5, B6, B7, B8, and B9 are commercially available.

The linker is selected to provide a suitable coupling of the building block to a support. The support can interact with the ligand as part of the capture agent. The linker can also provide bulk, distance from the support, hydrophobicity, hydrophilicity, and like structural characteristics to the building block. Coupling building blocks to the support can employ covalent bonding or noncovalent interactions. Suitable noncovalent interactions include interactions between ions, hydrogen bonding, van der Waals interactions, and the like. In an embodiment, the linker includes moieties that can engage in covalent bonding or noncovalent interactions. In an embodiment, the linker includes moieties that can engage in covalent bonding. Suitable groups for forming covalent and reversible covalent bonds are described hereinabove.

The linker can be selected to provide suitable reversible immobilization of the building block on a support or lawn. In an embodiment, the linker forms a covalent bond with a functional group on the support. In an embodiment, the linker also includes a functional group that can reversibly interact with the support or lawn, e.g., through reversible covalent bonding or noncovalent interactions.

In an embodiment, the linker includes one or more moieties that can engage in reversible covalent bonding. Suitable groups for reversible covalent bonding include those described hereinabove. An capture agent can include building blocks reversibly immobilized on the lawn or support through, for example, imine, acetal, ketal, disulfide, ester, or like linkages. Such functional groups can engage in reversible covalent bonding. Such a functional group can be referred to as a covalent bonding moiety, e.g., a second covalent bonding moiety.

In an embodiment, the linker can be functionalized with moieties that can engage in noncovalent interactions. For example, the linker can include functional groups such as an ionic group, a group that can hydrogen bond, or a group that can engage in van der Waals or other hydrophobic interactions. Such functional groups can include cationic groups, anionic groups, lipophilic groups, amphiphilic groups, and the like.

In an embodiment, the present methods and compositions can employ a linker including a charged moiety (e.g., a second charged moiety). Suitable charged moieties include positively charged moieties and negatively charged moieties. Suitable positively charged moieties include protonated amines, quaternary ammonium moieties, sulfonium, sulfoxonium, phosphonium, ferrocene, and the like. Suitable negatively charged moieties (e.g., at neutral pH in aqueous compositions) include carboxylates, phenols substituted with strongly electron withdrawing groups (e.g., tetrachlorophenols), phosphates, phosphonates, phosphinates, sulphates, sulphonates, thiocarboxylates, and hydroxamic acids.

In an embodiment, the present methods and compositions can employ a linker including a group that can hydrogen bond, either as donor or acceptor (e.g., a second hydrogen bonding group). For example, the linker can include one or more carboxyl groups, amine groups, hydroxyl groups, carbonyl groups, or the like. Ionic groups can also participate in hydrogen bonding.

In an embodiment, the present methods and compositions can employ a linker including a lipophilic moiety (e.g., a second lipophilic moiety). Suitable lipophilic moieties include one or more branched or straight chain C₆₋₃₆ alkyl, C₈₋₂₄ alkyl, C₁₂₋₂₄ alkyl, C₁₂₋₁₈ alkyl, or the like; C₆₋₃₆ alkenyl, C₈₋₂₄ alkenyl, C₁₂₋₂₄ alkenyl, C₁₂₋₁₈ alkenyl, or the like, with, for example, 1 to 4 double bonds; C₆₋₃₆ alkynyl, C₈₋₂₄ alkynyl, C₁₂₋₂₄ alkynyl, C₁₂₋₁₈ alkynyl, or the like, with, for example, 1 to 4 triple bonds; chains with 1-4 double or triple bonds; chains including aryl or substituted aryl moieties (e.g., phenyl or naphthyl moieties at the end or middle of a chain); polyaromatic hydrocarbon moieties; cycloalkane or substituted alkane moieties with numbers of carbons as described for chains; combinations or mixtures thereof; or the like. The alkyl, alkenyl, or alkynyl group can include branching; within chain functionality like an ether group; terminal functionality like alcohol, amide, carboxylate or the like; or the like. In an embodiment the linker includes or is a lipid, such as a phospholipid. In an embodiment, the lipophilic moiety includes or is a 12-carbon aliphatic moiety.

In an embodiment, the linker includes a lipophilic moiety (e.g., a second lipophilic moiety) and a covalent bonding moiety (e.g., a second covalent bonding moiety). In an embodiment, the linker includes a lipophilic moiety (e.g., a second lipophilic moiety) and a charged moiety (e.g., a second charged moiety).

In an embodiment, the linker forms or can be visualized as forming a covalent bond with an alcohol, phenol, thiol, amine, carbonyl, or like group on the support. Between the bond to the support and the group participating in or formed by the reversible interaction with the support or lawn, the linker can include an alkyl, substituted alkyl, cycloalkyl, heterocyclic, substituted heterocyclic, aryl alkyl, aryl, heteroaryl, heteroaryl alkyl, ethoxy or propoxy oligomer, a glycoside, or like moiety.

For example, suitable linkers can include: the functional group participating in or formed by the bond to the support, the functional group or groups participating in or formed by the reversible interaction with the support or lawn, and a linker backbone moiety. The linker backbone moiety can include about 4 to about 48 carbon or heteroatoms, about 8 to about 14 carbon or heteroatoms, about 12 to about 24 carbon or heteroatoms, about 16 to about 18 carbon or heteroatoms, about 4 to about 12 carbon or heteroatoms, about 4 to about 8 carbon or heteroatoms, or the like. The linker backbone can include an alkyl, substituted alkyl, cycloalkyl, heterocyclic, substituted heterocyclic, aryl alkyl, aryl, heteroaryl, heteroaryl alkyl, ethoxy or propoxy oligomer, a glycoside, mixtures thereof, or like moiety.

In an embodiment, the linker includes a lipophilic moiety, the functional group participating in or formed by the bond to the support, and, optionally, one or more moieties for forming a reversible covalent bond, a hydrogen bond, or an ionic interaction. In such an embodiment, the lipophilic moiety can have about 4 to about 48 carbons, about 8 to about 14 carbons, about 12 to about 24 carbons, about 16 to about 18 carbons, or the like. In such an embodiment, the linker can include about 1 to about 8 reversible bond/interaction moieties or about 2 to about 4 reversible bond/interaction moieties. Suitable linkers have structures such as (CH₂)ₙCOOH, with n=12-24, n=17-24, or n=16-18.

The linker can be selected to provide a suitable covalent coupling of the building block to a support. The support can interact with the ligand as part of the capture agent. The linker can also provide bulk, distance from the support, hydrophobicity, hydrophilicity, and like structural characteristics to the building block. In an embodiment, the linker forms a covalent bond with a functional group on the support. In an embodiment, before attachment to the support the linker also includes a functional group that can be activated to react with or that will react with a functional group on the support. In an embodiment, once attached to the support, the linker forms a covalent bond with the support and with the support.

In an embodiment, the linker forms or can be visualized as forming a covalent bond with an alcohol, phenol, thiol, amine, carbonyl, or like group on the support. The linker can include a carboxyl, alcohol, phenol, thiol, amine, carbonyl, maleimide, or like group that can react with or be activated to react with the support. Between the bond to the support and the group formed by the attachment to the support, the linker can include an alkyl, substituted alkyl, cycloalkyl, heterocyclic, substituted heterocyclic, aryl alkyl, aryl, heteroaryl, heteroaryl alkyl, ethoxy or propoxy oligomer, a glycoside, or like moiety.

The linker can include a good leaving group bonded to, for example, an alkyl or aryl group. The leaving group being “good” enough to be displaced by the alcohol, phenol, thiol, amine, carbonyl, or like group on the support. Such a linker can include a moiety represented by the formula: R—X, in which X is a leaving group such as halogen (e.g., —Cl, —Br or —I), tosylate, mesylate, triflate, and R is alkyl, substituted alkyl, cycloalkyl, heterocyclic, substituted heterocyclic, aryl alkyl, aryl, heteroaryl, heteroaryl alkyl, ethoxy or propoxy oligomer, a glycoside, or like moiety.

Suitable linker groups include those of formula: (CH₂)ₙCOOH, with n=1-16, n=2-8, n=2-6, or n=3. Reagents that form suitable linkers are commercially available and include any of a variety of reagents with orthogonal functionality.

In an embodiment, removal unit building block(s) can be represented by Formula 2:

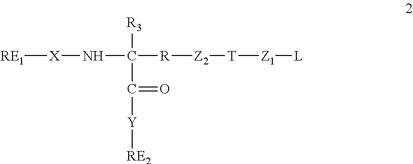

in which: RE₁ is removal unit 1, RE₂ is removal unit 2, T is an optional tether, and L is a linker. X is absent, C═O, CH₂, NR, NR₂, NH, NHCONH, SCONH, CH═N, or OCH₂NH. In certain embodiments, X is absent or C═O. Y is absent, NH, O, CH₂, or NRCO. In certain embodiments, Y is NH or O. In an embodiment, Y is NH. Z₁ and Z₂ can independently be CH₂, O, NH, S, CO, NR, NR₂, NHCONH, SCONH, CH═N, or OCH₂NH. In an embodiment, Z₁ and/or Z₂ can independently be O. Z₂ is optional. R₂ is H, CH₃, or another group that confers chirality on the building block and has size similar to or smaller than a methyl group. R₃ is CH₂; CH₂-phenyl; CHCH₃; (CH₂)ₙ with n=2-3; or cyclic alkyl with 3-8 carbons, e.g., 5-6 carbons, phenyl, naphthyl. In certain embodiments, R₃ is CH₂ or CH₂-phenyl.

RE₁ is B1, B2, B3, B3a, B4, B5, B6, B7, B8, B9, A1, A2, A3, A3a, A4, A5, A6, A7, A8, or A9. In certain embodiments, RE₁ is B1, B2, B3, B3a, B4, B5, B6, B7, B8, or B9. RE₂ is A1, A2, A3, A3a, A4, A5, A6, A7, A8, A9, B1, B2, B3, B3a, B4, B5, B6, B7, B8, or B9. In certain embodiments, RE₂ is A1, A2, A3, A3a, A4, A5, A6, A7, A8, or A9. In an embodiment, RE₁ can be B2, B3a, B4, B5, B6, B7, or B8. In an embodiment, RE₂ can be A2, A3a, A4, A5, A6, A7, or A8.

T can be any of the tether moieties described hereinabove.

In an embodiment, L is the functional group participating in or formed by the bond to the support (such groups are described herein), the functional group or groups participating in or formed by the reversible interaction with the support or lawn (such groups are described herein), and a linker backbone moiety. In an embodiment, the linker backbone moiety is about 4 to about 48 carbon or heteroatom alkyl, substituted alkyl, cycloalkyl, heterocyclic, substituted heterocyclic, aryl alkyl, aryl, heteroaryl, heteroaryl alkyl, ethoxy or propoxy oligomer, a glycoside, or mixtures thereof; or about 8 to about 14 carbon or heteroatoms, about 12 to about 24 carbon or heteroatoms, about 16 to about 18 carbon or heteroatoms, about 4 to about 12 carbon or heteroatoms, about 4 to about 8 carbon or heteroatoms.

In an embodiment, the L is the functional group participating in or formed by the bond to the support (such groups are described herein) and a lipophilic moiety (such groups are described herein) of about 4 to about 48 carbons, about 8 to about 14 carbons, about 12 to about 24 carbons, about 16 to about 18 carbons. In an embodiment, this L also includes about 1 to about 8 reversible bond/interaction moieties (such groups are described herein) or about 2 to about 4 reversible bond/interaction moieties. In an embodiment, L is (CH₂)ₙCOOH, with n=12-24, n=17-24, or n=16-18. In an embodiment, L is (CH₂)ₙCOOH, with n=1-16, n=2-8, n=4-6, or n=3. Preferred removal units are as compound I-V as follows:

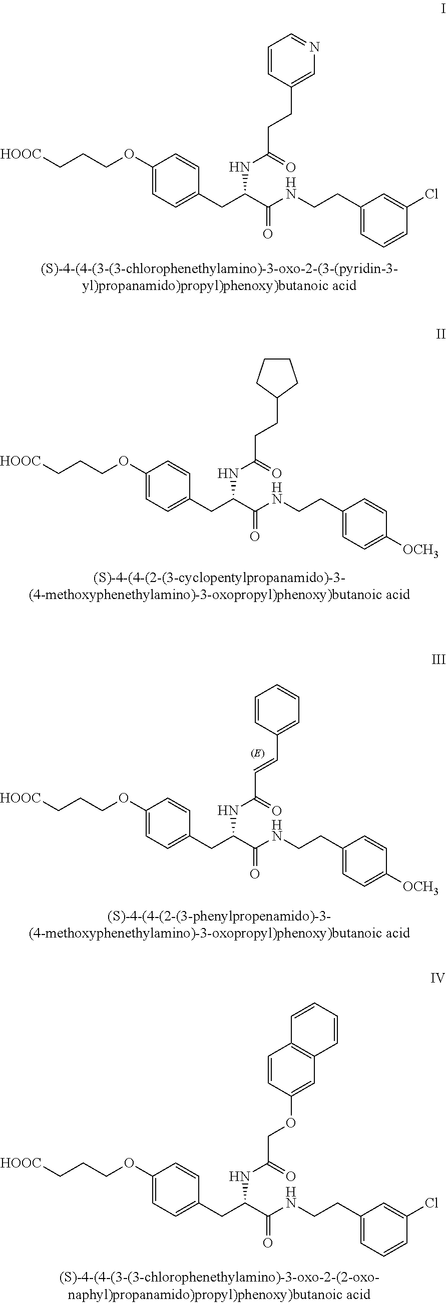

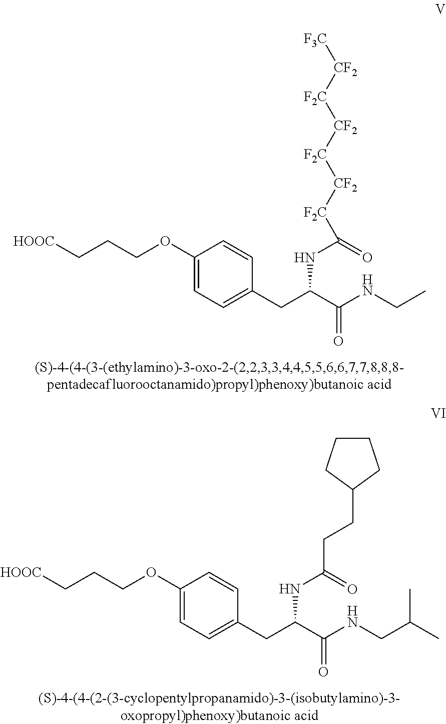

### Amines and Polyamines

Useful amines for amine capture units for microbial removal include protonated amines, quaternary ammonium moieties and amines include alkyl amines, alkyl diamines, heteroalkyl amines, aryl amines, heteroaryl amines, aryl alkyl amines, pyridines, heterocyclic amines (saturated or unsaturated, the nitrogen in the ring or not), amidines, hydrazines, and the like. Alkyl amines generally have 1 to 12 carbons, e.g., 1-8, and rings can have 3-12 carbons, e.g., 3-8. Suitable heterocyclic or alkyl heterocyclic amines can be used. Any of the amines can be employed as a quaternary ammonium compound. Additional suitable quaternary ammonium moieties include trimethyl alkyl quaternary ammonium moieties, dimethyl ethyl alkyl quaternary ammonium moieties, dimethyl alkyl quaternary ammonium moieties, aryl alkyl quaternary ammonium moieties, pyridinium quaternary ammonium moieties, and the like.

Polyamines includes an amine containing repeating units of a secondary amine (—NH) with alternating units of a C₂₋₁₀ alkylene group. Both the nitrogen and the carbons of the polyamine can be modified or substituted. A preferred polyamine is according to the structure:

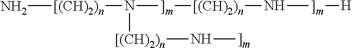

wherein n is independently 2 to 10 and m is independently 2 to 2000; or

NH₂—[(CH)₂)ₙ—NH—]ₘ—H

wherein n is independently 2 to 10 and m is independently to 8. Preferred polyamines are triethylene-tetramine and tetraethylene-pentamine or mixtures thereof,

Such amines can be crosslinked in higher molecular weight amine compounds. Examples for crosslinking agents reacting with polyamines are multifunctional carboxylic acid, multifunctional acrylate, multifunctional esters, halohydrins, multifunctional halide, multifunctional isocyanate, transition metals like zinc. Useful crosslinkers are selected from the group of dicarboxylic acids and anhydrides including oxalic acid, malonic acid, maleic acid, and anhydride, succinic acid and anhydride, etc., sodium formate, poly (ethylene glycol) diglycidyl ethers. The optimal concentration of the crosslinking agent has to be adjusted depending on the activity for the agent and polyamine Inorganic crosslinkers include aluminates, silica acid alkali salt, silica and/or alumino-silicates. The use of aluminate compounds of the formula Mₙ[H₂ₙ₊₂AlₙO3ₙ₊₁], in which M is potassium or sodium and n is a whole number between 1 and 10.

TABLE 2
Loading amounts based on weight of fiber or surface
area of fabric, bat or nonwoven

| Organic Pendant | Fiber | Fiber | Fiber | Fabric | Fabric | Fabric |
|---|---|---|---|---|---|---|
| groups | mg-gm | mg-gm | mg-gm | mg-cm⁻² | mg-cm⁻² | mg-cm⁻² |
| Capture agent | 0.01-80 | 0.05-40 | 0.08-20 | 0.01-80 | 0.05-40 | 0.08-20 |
| Amine/polyamine | 0.01-80 | 0.05-40 | 0.08-20 | 0.01-80 | 0.05-40 | 0.08-20 |

### Methods of Binding

In an embodiment, methods and/or devices can be used for binding and removing (with a micro-biocidal or static growth result) a ligand. The present capture agents can be specific for a given ligand, or broad spectrum to G+, G− bacteria, fungi and viri.

For example, the fiber with a capture/removal unit can be contacted with a surface in a wet environment including or suspected of including at least one microbial contaminant. Binding to the capture agents can be obtained. We have found that greater than 80% or up to 99.99% binding of the contamination can be achieved. For example, a capture agent that binds (e.g., tightly) the molecule, virus, cell, or microbe under appropriate conditions can be employed in a format where binding itself is sufficient to indicate presence of the molecule or organism.

In an embodiment, the method can include producing or employing the selected working capture agent or receptor complex on a substrate. The substrate can include working capture agents for a single ligand or working capture agents for a plurality of ligands. For example, a method can include contacting the capture agents with a fluid sample.

In an embodiment, a method is disclosed for binding and removing an organism such as a bacterial organism, fungal organism, biological protein (prions), surface (microbial surface) molecule, virus or other harmful cell. This embodiment of the method can include selecting an capture/removal agent that binds the infective unit from an array of capture agents, contacting the capture agent with a test composition, and binding with an optimal detecting binding of the capture agent to the test composition.

Microbes of clinical or environmental interest include bacteria, mycoplasma, fungus, rickettsia, or virus. Suitable bacteria or mycoplasma of clinical or environmental interest include Escherichia coli, Vibrio cholerae, Acinetobacter caicoaceticus, Haemophilus influenzae, Actinobacillus actinoides, Haemophilus parahaemolyticus, Actinobacillus lignieresii, Haemophilus parainfluenzae, Actinobacillus suis, Legionella pneumophila, Actinomyces bovis, Leptospira interrogans, Actinomyces israelli, Mima polymorpha, Aeromonas hydrophila, Moraxella lacunata, Arachnia propionica, Burkholderia mallei, Burkholderia pseudomallei, Moraxella osioensis, Arizona hinshawii, Mycobacterium osioensis, Bacillus cereus, Mycobacterium leprae, Bacteroides spp, Mycobacterium spp, Bartonella bacilliformis, Plesiomonas shigelloides, Bordetella bronchiseptica, Proteus spp, Clostridium difficile, Pseudomonas aeruginosa, Clostridium sordellii, Salmonella cholerasuis, Clostridium tetani, Salmonella enteritidis, Corynebacterium diphtheriae, Salmonella typhi, Edwardsiella tarda, Serratia marcescens, Enterobacter aerogenes, Shigella spp, Staphylococcus epidermidis, Francisella novicida, Vibrio parahaemolyticus, Haemophilus ducreyi, Haemophilus gallinarum, Haemophilus haemolyticus, Bacillus anthracis, Mycobacterium Bovis, Bordetella pertussis, Mycobacterium tuberculosis, Borrella burgdorfii, Mycoplasma pneumoniae, Borrella spp, Neisseria gonorrhoeae, Campylobacter, Neisseria meningitides, Chlamydia psittaci, Nocardia asteroids, Chlamydia trachomatis, Nocardia brasillensis, Clostridium botulinum, Pasteurella haemolytica, Clostridium chauvoei, Pasteurelia multocida, Clostridium haemolyticus, Pasteurella pneumotropica, Clostridium histolyticum, Pseudomonas pseudomallei, Clostridium novyl, Staphylococcus aureus, Clostridium perfringens, Streptobacillus moniliformis, Clostridium septicum, Cyclospora cayatanensis, Streptococcus agalacetiae, Erysipelothrix insidiosa, Streptococcus pneumoniae, Klebsiella pneumoniae, Streptococcus pyogenes, Listeria manocytogenes, Yersinia pestis, Yersinia pseudotuberculosis, Yersinia enterocolitica, Brucella abortus, Brucella canis, Brucella melitensis, Brucella suis, and Francisella tularensis.

Fungus include Absidia, Piedraia hortae, Aspergillus, Prototheca, Candida, Paecilomyces, Cryptococcus neoformans, Cryptosporidium parvum, Phialaphora, Dermatophilus congolensis, Rhizopus, Epidermophyton, Scopulariopsis, Exophiala, Sporothrix schenkii, Fusarium, Trichophyton, Madurella mycetomi, Toxoplasma, Trichosporon, Microsporum, Microsporidia, Wangiella dermatitidis, Mucor, Blastomyces dermatitidis, Giardia lamblia, Entamoeba histolytica, Coccidioides immitis, and Histoplasma capsulatum.

Rickettsia or viruses of clinical or environmental interest include Coronaviruses, Hepatitis viruses, Hepatitis A virus, Myxo-Paramyxoviruses (Influenza viruses, Measles virus, Mumps virus, Newcastle disease virus), Picornavirus (Coxsackie viruses, Echoviruses, Poliomyelitis virus), Rickettsia akari, Rochalimaea Quintana, Rochalimaea vinsonii, Norwalk Agent, Adenoviruses, Arenaviruses (Lymphocytic choriomenigitis, Viscerotrophic strains), Herpesvirus Group (Herpesvirus hominis, Cytomegalovirus, Epstein-Barr virus, Caliciviruses, Pseudo-rabies virus, Varicella virus), Human Immunodeficiency Virus, Parainfluenza viruses (Respiratory syncytial virus, Subsclerosing panencephalitis virus), Picornaviruses (Poliomyelitis virus), Poxviruses Variola, Cowpox virus (Molluscum contagiosum virus, Monkeypox virus, Orf virus, Paravaccinia virus, Tanapox virus, Vaccinia virus, Yabapox virus), Papovaviruses (SV 40 virus, B-K-virus), Spongiform Encephalopathy Viruses (Creutzfeld-Jacob agent, Kuru agent, BSE), Rhabdoviruses (Rabies virus), Tobaviruses (Rubella virus), Coxiella burnetii, Rickettsia canada, Rickettsia prowazekii, Rickettsia rickettsii, Rickettsia Tsutsugamushi, Rickettsia typhi (R. mooseri), Spotted Fever Group Agents, Vesicular Stomatis Virus (VSV), and Toga, Arena (e.g., LCM, Junin, Lassa, Marchupo, Guanarito, etc.), Bunya (e.g., hantavirus, Rift Valley Fever, etc.), Flaviruses (Dengue), and Filoviruses (e.g., Ebola, Marburg, etc.) of all types, Nipah virus, viral encephalitis agents, LaCrosse, Kyasanur Forest virus, Yellow fever, and West Nile virus.

Microbes of clinical or environmental interest include Variola Viruses, Congo-Crimean hemorrhagic fever, Tick-borne encephalitis virus complex (Absettarov, Hanzalova, Hypr, Kumlinge, Kyasanur Forest disease, Omsk hemorrhagic fever, and Russian Spring-Summer Encephalitis), Marburg, Ebola, Junin, Lassa, Machupo, Herpesvirus simiae, Bluetongue, Louping III, Rift Valley fever (Zing a), Wesselsbron, Foot and Mouth Disease, Newcastle Disease, African Swine Fever, Vesicular exanthema, Swine vesicular disease, Rinderpest, African horse sickness, Avian influenza, and Sheep pox. Other components of interest include Ricinus communis.

A candidate capture agent, a lead capture agent, or a working capture agent includes combination of building blocks immobilized (e.g., reversibly) on a support or with an amine. An individual capture agent can be a heterogeneous building block on a fiber. The building blocks can be immobilized through any of a variety of interactions, such as covalent, electrostatic, or hydrophobic interactions. For example, the building block and support or lawn can each include one or more functional groups or moieties that can form covalent, electrostatic, hydrogen bonding, van der Waals, or like interactions.

Capture/removal agents, particularly candidate or lead capture agents, can be in the form of a single amine or a single capture agent or a combination of amine(s) and capture agent(s).

In an embodiment, an array of candidate capture agents includes building blocks of general Formula 2 (shown hereinabove), with RE₁ being B1, B2, B3, B3a, B4, B5, B6, B7, B8, or B9 (shown hereinabove) and with RE₂ being A1, A2, A3, A3a, A4, A5, A6, A7, A8, or A9 (shown hereinabove).

One or more working capture agents can be developed from one or more lead capture agents. In an embodiment, the capture agent includes a plurality of building blocks coupled to a support. In an embodiment, the plurality of building blocks can include or be building blocks of Formula 2 (shown hereinabove). An abbreviation for the building block including a linker, a tether, a tyrosine and removal units AxBy is tether-TyrAxBy. In an embodiment, a candidate capture agent can include combinations of building blocks of formula tether-TyrA1B1, tether-TyrA2B2, tether-TyrA2B4, tether-TyrA2B6, tether-TyrA2B8, tether-TyrA3B3, tether-TyrA4B2, tether-TyrA4B4, tether-TyrA4B6, tether-TyrA4B8, tether-TyrA5B5, tether-TyrA6B2, tether-TyrA6B4, tether-TyrA6B6, tether-TyrA6B8, tether-TyrA7B7, tether-TyrA8B2, tether-TyrA8B4, tether-TyrA8B6, or tether-TyrA8B8.

The method uses capture agents to remove an infective unit from a surface.

According to the present method, screening candidate capture agents against a ligand can yield one or more lead capture agents. One or more lead capture agents can be a working capture agent. That is, the one or more lead capture agents can be useful for detecting the ligand of interest as is. The method can then employ the one or more capture agents as a working capture agent for monitoring or detecting the ligand. Alternatively, the one or more lead capture agents can be employed in the method for developing a working capture agent. For example, the one or more lead capture agents can provide structural or other information useful for designing or screening for an improved lead capture agent or a working capture agent. Such designing or screening can include making and testing additional candidate capture agents including combinations of a subset of building blocks, a different set of building blocks, or a different number of building blocks.

A building block reversibly immobilized by an imine, acetal, or ketal bond can be mobilized by decreasing the pH or increasing concentration of a nucleophilic catalyst in the environs of the building block. In an embodiment, the pH is about 1 to about 4. Imines, acetals, and ketals undergo acid catalyzed hydrolysis. A building block that is mobile on a support can be reversibly immobilized by a reversible covalent interaction, such as by forming an imine, acetal, or ketal bond, by increasing the pH.

In embodiments, the present disclosure provides an article comprising a fiber, collection of fiber (bat or mat), a woven or non-woven fabric, the fabric comprising a fiber, the fiber comprising a nonwoven web comprised of a cellulosic material, a thermoplastic polymer composition comprising a resin or blend of resins.

In one embodiment, the disclosure provides an article comprising a collection of fiber. Such a collection of fiber can be a random combination of one or more fibers of one or more types. Typical fiber types include cellulosic or synthetic polymeric fibers. The fibers can be loosely formed into a fiber collection such as a fiber mat, a fiber bat, or a felt. Such fabric collections can be used as absorbent layers, etc. In embodiments, the term fiber includes a linear structure having a diameter that can range from about 0.01 microns to as much as 500 microns but typically ranges from about 0.2 to about 50 microns typically in a length substantially in excess of the fiber diameter. Typically such fibers are made in indeterminate lengths and are later processed to form shorter lengths that can be used in the manufacture of fiber collections, or woven or nonwoven fiber fabrics. Fabric (woven or non-woven) thickness can be from 0.1 mm to 5 mm or more not including pads, foams or other supports. Fiber masses can be in an amount of about 1 gm to 5 Kg and can take any form including that of any surface, column or container thereof.

In embodiments, the present disclosure provides an article comprising a woven or nonwoven web. The nonwoven web comprises, for example, at least one of: a spunbond fabric, melt blown fabric, and combinations thereof. Combinations of spunbond fabric and melt blown fabric are known and can be, for example, spunbond-melt blown-spun bond (SMS), spunbond-melt blown-melt blown-spunbond (SMMS), and like permutations or combinations. Preferred webs are combination of cellulosic fiber and synthetic fiber, such as cellulose/polyester called polycellulose, a nonwoven fabric of about 25% to 75% cellulose fiber and 75% to 25% polyester. Such fiber is inter-mingled using conventional techniques. The nonwoven web may also comprise, for example, bonded carded webs (BCW) which is made from, for example, carded staple fibers which are, for example, bonded together in heat fused discreet bonds, chemical bonds in some pattern or chemical bonds at most fiber crossings and the like.

Nonwoven webs of the disclosure can be fashioned into sheets or fabrics using any suitable method. Nonwoven fabrics and articles prepared there from can be categorized, for example, by their end use, such as disposable or durable product articles. It will be appreciated that such categorizations may be arbitrary and that such categories may include articles in either or both categories, and can depend, for example, on the user's discretion to determine useful service life, reuse or recycle opportunities, wear-and-tear assessment, or like considerations. Thus, durable paper formulations can be used in disposable garments, and like articles. Likewise, disposable web or fabric compositions or formulations can be used in the manufacture of durable product articles. Examples of traditional disposables include, for example, disposable baby diaper products, feminine hygiene products, adult incontinence products, protective garments, medical fabrics, wound dressings and like products. Disposables can be prepared using, for example, spunbond webs, meltblown webs, carded thermal bonded webs, carded chemically bonded webs, film, and like methods. Spunbond and SMS fabrics can be used for example in healthcare products, such as surgical pack items and medical protective apparel. Spunbonds can be used, for example, in fabric softener sheets, and like sheets or wipes. Durable fabric and durable article end uses include, for example, a variety of filtration products, and building and construction products, where nonwovens can be used, for example, in geotextiles and roofing products. Modified bitumen products that include a spunbond carrier are popular for residential and commercial roofing. Automobile primary carpet backing and carpet tiles can use spunbond materials, which can provide excellent working properties such as moldability, high dimensional, and heat stability.

A variety of product applications or uses exist for the nonwoven fabric articles of the disclosure. Product fabric applications can include, for example, disposable diapers and incontinence garments, or components thereof, such as cloth-like backsheet, leg cuff, and cover stock components. Another product application or use for the nonwoven fabric articles of the disclosure include durable papers or wraps, for example, for use in the home building or construction industry, such as is currently fashioned from Tyvek® polyethylene spunbond fabric. Another product application or use for the nonwoven fabric and articles of the disclosure include disposable, protective apparel such as a hazardous-material suit or like apparel, such as can be currently fashioned from Tyvek® polyethylene or polypropylene spunbond fabric, or like materials. Still another product application or use for the nonwoven fabric and articles of the disclosure include household or pet care articles, such as bedding, pillows, furnishings, and like articles which can employ, for example, polypropylene spunbond, polyester spunbond, and like prepared materials. Still yet another product application or use for the nonwoven fabric and articles of the disclosure include geotextiles or a geotextile component comprising, for example, a heavyweight polypropylene and polyester spunbond, alone or in combination with needlepunch polypropylene and woven fabrics. Yet another product application or use for the nonwoven fabric and articles of the disclosure includes furniture or a furniture component comprising, for example, a polypropylene spunbond fabric, a polypropylene needlepunch fabric, or a polyester spunbond fabric. Yet another product application or use for the nonwoven fabric and articles of the disclosure includes a filter or a filter component comprising, for example, spunbond fabric, meltblown fabric, or combinations thereof, and which article or component can be used in liquid filtration or air filtration applications. Still another product application or use for the nonwoven fabric and articles of the disclosure includes a surface covering, such as a wall or floor covering, or a surface covering component comprising, for example, residential, commercial, institutional, automotive, and like situational carpets made from, for example, trim heavyweight polyester spunbond fabrics, carpet underlays or carpet backings consisting of, for example, PET, polyamide, or polypropylene spunbond fabrics. Other product application or use for the nonwoven fabric and articles of the disclosure includes a surface covering, such as a roof or roofing material, or a roof or roofing material component, comprising, for example, polyester spunbonds. Another product application or use for the nonwoven fabric and articles of the disclosure includes a medical product, or a medical product component comprising, for example, a fabric including a spunbond and spunbond/meltblown composite.

Meltblown and spunbond nonwovens fiber technology heats and extrudes polymers including, for example, biodegradables, nylon, polyethylene, polyesters, polypropylene, and polyamides through a specialized die onto a forming table to create a web. Meltblown webs can be used for applications such as filtration, insulation, absorption, and vapor or liquid barriers. A system operator can vary the fiber and cyclodextrin pore size of the meltblown web to accommodate the customer's absorption and filtration specifications. End products or articles employing or incorporating meltblown fabrics include, for example, surgical, masks, diapers, battery separators, liquid and air filters, and like products or articles. Spunbond fabrics can be used in a variety of useful applications including, for example, filtration, insulation, carrier web, textile, and like applications with various end products such as surgical apparel, diapers, carpet backing, liquid and air filters, and like articles.

As in the meltblown process, the spunbond system operator can vary the fiber and pore sizes of the web to meet a broad range of containment properties. In addition, spunbond fabric can be manufactured to accommodate required strength characteristics. Meltblown and spunbond webs can be used together as a composite fabric, providing control over absorption and filtration characteristics, as well as strength. Composite webs comprising combinations of spunbond and meltblown webs also have a variety of applications and end uses. SMS (spunbond-meltblown-spunbond) and SMMS (spunbond-meltblown-meltblown-spunbond) technologies for baby diapers include, for example, standing leg gathers, soft outer cover, stretchable fastening tapes, and stretchable outer covers and panels.

Nonwoven fiber technology incorporating the polymer compositions of the disclosure provide a cost-efficient way to create a broad range of products that can filter and absorb very precisely. Uses include, but are not limited to, for example, surgical masks, wound dressings, wipes, liquid and air filters, diapers, carpet backing, and like uses. See for example, “Fiber Systems Technology Primer, An Introduction to Spunbond and Meltblown,” Nordson Fiber Systems (available at: www.nordson.com, Jul. 28, 2006); and “Spunbond Manufacture Process Optimisation by Melt Filtration” by Dr. Oliver Schmidt, Gneuss Kunststofftechnik GmbH (available at: www.nonwovens-industry.com, Jul. 28, 2006).

The following table lists several common methods for nonwoven web manufacture and typical or approximate fiber diameters provided by or employed by these methods. It is generally recognized that as the fiber diameter selected decreases in size the surface area of the resulting web proportionately increases with the square of the fiber diameter decrease.

TABLE 3

| | Fiber size (diameter); |
|---|---|
| Method/Fiber Type | bundle size |
| Electrospinning | 10 to 1000 nm; |
| | Low fiber bundles |
| Meltblowing | 500 nm to 10 microns; |
| | High fiber bundles |
| Flash spinning | 2-15 microns; |
| | High fiber bundles |
| Spunbonding | 10-35 microns; |
| | Low to medium fiber |
| | bundles |
| Bicomponent fibers | 200 nm to 1000 nm |

Spunmelt processes are used in the manufacture of spunbond (SB) nonwovens, and the hybrid meltblown (MB) nonwovens, and combinations of the two, and are made by extruding molten polymer through spinnerets to form fibers. Spunmelt currently dominates in the medical drape and gown market providing a diversified product spectrum from a range of microfibers. In electrospinning, nonwoven fabric of submicron solid fibers are drawn from a viscous polymer (solution or melt) stream delivered through a capillary tube with a high voltage electric field.

SB, MB, flash spinning (FS), and electrostatic spinning (ES) are among the more popular processes for producing microfiber nonwovens. Although these processes are very different from one another, they all share the same character of making a fibrous product from a polymer in one-step.

Fibers produced from a SB technology can have an average fiber diameter, in the upper limit of a microfiber concept of, for example, from about 15 to about 35 microns. Recent development in bicomponent SB, combined with other technology, such as hydro-entanglement, can provide even finer SB fibers.

MB processing can also make microfibers on the micron or sub-micron scale. MB microfibers can be engineered for a broad spectrum of applications, such as medical fabrics, filter media, protective clothes, and absorbent products. The MB process can be exploited in a variety of aspects, including use of specialty polymers, developing unique fiber and web structures, bicomponent, and microfiber composites.

Microfibers are often used in composite structures to balance properties. The composite can be, for example, spunbond/melt blown/spunbond (SMS), where the SB layers serve as the external skeleton to provide the strength and the support, whereas MB layers can contribute, for example, filtration and barrier characteristics. The technology allows the SB and/or MB section to include more than one layer for special applications, such as SMMS, SSMMS, and like structures.

SMS or SMMS fabrics have been widely used in products that require high barrier properties that are critical for applications in such fields as hygienic and medicine. The barrier properties of those materials are highly dependent on the performance of both ‘M’ and ‘S’ layers. In general, the finer the fiber sizes and the higher the weight of the ‘M’ layer, the greater the barrier properties the SMS or SMMS fabrics will possess.

Microfiber nonwoven composites having specialty chemical treatments can provide useful fabrics in the medical field. Combinations of SB and MB microfiber technologies and optionally treatment technologies can be used to further improve or add other functional properties, such as protection and comfort.

Increased demand for high levels of protection and comfort, and new industrial standards, have caused microfiber nonwovens to steadily replace traditional medical textiles globally. Microfiber nonwovens and their composites have been used in the medical field for several decades. These products find application in hospitals and other healthcare institutions in the form of, for example, drapes, gowns, caps, masks, bandages, sterilization wraps, and like uses. Although different products must deliver different functionalities, the following can be significant property considerations in the selection of most nonwovens in the medical field: barrier properties; breathability for gown application; drapeability; strength; and tactile softness.

Cotton-surfaced nonwovens in which carded bleached cotton/PP, cotton/PET, staple fiber webs (e.g., 60/40 cotton/PP (55/45; polyester/cellulose)) or hydro-entangled 100% cotton can be used, for example, to make face masks. The cotton surface of the cotton-surfaced nonwovens is ideally worn against the face for greater comfort. It is beneficial for the cotton surface to retain antimicrobial agents and contain fluorochemical repellents to enhance the ability of the face mask to kill bacteria and virus, and repel water and contaminants.

In embodiments, spunlaced fabrics can be made of combinations of wood pulp and synthetic fiber layered composites. Tissue paper, or unbonded wood pulp fibers can be layered on top of, for example, a carded or spunbond web prior to hydroentanglement. The fabric can have one side that is rich in wood pulp fiber. Additional chemical treatment can be added to the wood pulp fibers to achieve desired barrier properties.

In embodiments, the articles of the disclosure can include, for example, an absorbent core; a mixture of natural and synthetic fibers in the transfer layer; the acquisition layer, or both, breathable; stretchable; shape or body-conforming; cloth-like aesthetics and feel; odor control; metallocene polypropylene or like resins; reactive absorbent (super absorbent polymer) polymers (e.g., for personal care articles); ultra-thin layer(s) and construction (e.g., for personal care or hygiene products articles); antimicrobial surface treatment; reactive fibers; scavenging fibers (e.g., cyclodextrin, zeolite, activated charcoal, and like scavengers); biodegradable polymer materials (PLA, Bio-PET, Kenaf, and like materials); reduced basis weight; or combinations thereof.

In addition to the abovementioned monofiber methods and materials, the non-woven webs and fabrics fashioned there from can be comprised of, or include, bi-component fibers. Bi-component (bico or conjugate) technology enables manufacturers to, for example: reduce cost; improve strength and softness; produce ultra-fine fibers; provide improved loft, crimp, or both; and like process and product improvements. Typical bi-component fiber products include, for example, sheath and core, side-by-side, islands-in-the-sea and splittables (also known as segmented pie).

Nanofiber processing can include, for example, electrospinning, where fibers are spun with diameters of from about 10 nm to several hundred nanometers. The resulting fiber properties can depend on, for example, field uniformity, polymer viscosity, electric field strength, the distance between nozzle and collector, and like considerations. The production rate is typically low, such as grams per hour. Another nanofiber processing can include, for example, bi-component fiber spinning techniques which can produce, for example, “Islands-In-The-Sea” fibers, for example, of about 1-3 denier with from about 240 to about 1,120 filaments surrounded by a dissolvable polymer. Dissolving the outer “sea” polymer leaves a matrix of nanofibers, which can be further separated by stretching or mechanical agitation. The polymer ratio is generally 80% islands (nanofilaments) and 20% sea. The nanofilaments, resulting after dissolving the sea polymer component, have a diameter of, for example, about 300 nm. Compared to electrospinning, nanofibers produced with this technique can have a very narrow but coarser diameter range.

Web production methods useful for fiber and fabric preparation can include any other suitable method, such as spunlace, porous film, co-form, bonded-carded, needle punch, airlaid, wetlaid, and like methods, or combinations thereof. Spunlace processing, also known as hydroentangling, involves mechanically wrapping and knotting fibers in a web through the use of high velocity jets of water. Spunlaced nonwovens work well for wipes because they are soft, strong, and easy to handle, and provide good absorption. In embodiments, methods useful for fiber and fabric preparation can additionally include any other suitable processing methods, for example, thermo-bonding, chemical or resin bonding, and like methods. In embodiments, methods useful for fiber and fabric preparation can additionally include other suitable functional or performance additives or treatments, for example, an antimicrobial, an anti-stat, a flame retardant, a fluorochemical, a wetting agent, an ultraviolet stabilizer, a lamination, a binder or an adhesive, a melt adhesive, and like additives or treatments, or combinations thereof. In embodiments, depending upon its disposition and purpose in the fiber or final article, an additive can be included, for example, in a masterbatch, added directly to an extruder, applied topically to a fiber or web surface, and like inclusion methods, or combinations thereof. In embodiments, a binder or an adhesive can include, for example, an acrylic, a hot melt, a latex, a polyvinyl chloride, a pressure sensitive adhesive, a styrenated acrylic, styrene butadiene, vinyl acetate, ethylene vinyl acetate, vinyl acrylic, a melt-fusible fiber, a partially meltable bicomponent fiber (e.g., PE/PP, PE/PET, specially formulated PET/PET), and like materials, or combinations thereof. Both staple and spunlaid nonwovens would have no mechanical resistance in and of themselves, without the bonding step. Several methods can be used including thermal bonding, use of a heat sealer calendering through heated rollers (called spunbond when combined with spunlaid webs), calenders can be smooth faced for an overall bond or patterned for a softer, more tear resistant bond, hydro-entanglement: mechanical intertwining of fibers by water jets (called spunlace), ultrasonic pattern bonding: used in high-loft or fabric insulation/quilts/bedding needlepunching/needlefelting: mechanical intertwining of fibres by needles chemical bonding (wetlaid process): use of binders (such as latex emulsion or solution polymers) to chemically join the fibers. A more expensive route uses binder fibres or powders that soften and melt to hold other non-melting fibres together one type of cotton staple nonwoven is treated with sodium hydroxide to shrink bond the mat, the caustic causes the cellulose-based fibres to curl and shrink around one another as the bonding technique meltblown: fibre is bonded as air attenuated fibers intertangle with themselves during simultaneous fiber and web formation. Spunjet is the bonding of the Spunlaid filaments thanks to the hydroentanglement Nonwovens can also start with films and fibrillate, serrate or vacuum-form them with patterned holes. Fiberglass nonwovens that can be used are of two basic types. Wet laid mat or “glass tissue” use wet-chopped, heavy denier fibers in the 6 to 20 micrometre diameter range. Flame attenuated mats or “batts” use discontinuous fine denier fibres in the 0.1 to 6 range. The latter is similar, though run at much higher temperatures, to meltblown thermoplastic nonwovens. Wet laid mat is almost always wet resin bonded with a curtain coater, while batts are usually spray bonded with wet or dry resin.

In embodiments, the present disclosure provides a disposable article comprising a fabric formed from or by incorporating any of the aforementioned nonwoven web fibers. The fabric can be used to make or can be incorporated in, for example, an absorbent article for human or animal use, for example, at least one of: an incontinent under garment; a sanitary napkin; a wipe sheet; a tissue sheet; an underarm shield; and like absorbent articles; or combinations thereof.

In embodiments, the present disclosure provides a disposable article comprising a food package formed from or by incorporating any of the aforementioned nonwoven web fibers. The fibers can be used to make or can be incorporated in, for example, a fabric, a sheet, a liner, and like structures or layers which can be incorporated in, for example, a food package, or food package component, for example, at least one of: a tray;

a packing liner; a barrier layer; a scavenger layer; and like food package components; or combinations thereof.

In embodiments, the present disclosure provides an article comprised of a fabric, the fabric being fashioned into, for example, a medical article, or medical article component, such as: a mask; a garment; a drape; a bandage; a wound dressing; a bedding material; and like medical articles; or combinations thereof.

In embodiments, the present disclosure provides an article comprised of a fabric, the fabric being fashioned into, for example, a clothing article, or clothing article component, such as, a garment; a chemically resistant garment; a protective work garment; a garment liner; a garment accessory; a garment accessory liner; a foot wear liner; and like articles or components, or combinations thereof.

A garment accessory includes, for example, a hat, a scarf, a necktie, a glove, a mitten, a hanky, a handbag, a purse, a wallet, a watch band, a backpack, and like articles. A foot wear liner includes, for example, a shoe liner, a boot liner, a support liner or insole insert, a sandal liner, and like articles.

In embodiments, the present disclosure provides a disposable or durable article comprised of a fabric, the fabric being fashioned into, for example, a household article, or household article component, such as, a bedding material; a furniture liner; a carpet backing; a refuse lid liner; a refuse container; a refuse container liner; and like articles or components, or combinations thereof.

In embodiments, the present disclosure provides a disposable or durable article comprised of a fabric, the fabric being fashioned into, for example, a pet care article, or pet care article component, such as, a bedding material; a wipe sheet; a towel; a mat; a collar; a garment; a foot wear or paw wear liner, such as a “bootie” or sock which can be integral to or separable from the wear article; a cage liner; and like articles or components, or combinations thereof.

A bedding material for human or animal use can include, for example, a mattress cover, a mattress pad, a pillow case, a bed sheet, and like materials or articles.

In embodiments, the present disclosure provides a disposable article comprised of a fabric, the fabric being fashioned into, for example, a pet care article, or pet care article component, such as: a garment liner; a garment accessory; a garment accessory liner; and like articles or components, or combinations thereof.

In embodiments, the present disclosure provides an article comprising a fiber collection woven or nonwoven fabric that can be used in active sampling structures for detection and diagnostic properties including medical swabs for services, medical swabs for clinical applications.

A food package article or food package component of the disclosure can be, for example, a tray, a packing liner, a barrier layer, a scavenger layer, and like components, or combinations thereof that can remove and render an infective unit non-hazardous.

Long-established food packaging concepts are limited in their ability to extend the shelf-life of food products. Innovative food packaging concepts of the disclosure can, for example, interact with the environment inside the package and limit microbial growth.

Multi-layer or composite packages, including gable top cartons, rely on essential layers of plastic that adds strength, barrier to other materials in the structure, and sealability. By way of example, gable-top milk and juice cartons are specifically disclosed in U.S. Pat. Nos. 5,816,487, 5,508,075, 5,616,353, 6,193,827 and 6,372,317, as liquid tight containers. While these familiar gable-top cartons have been extensively used throughout the United States to contain juices, they are associated with some problems. Most interior polyolefin food contact or sealant layers scalp low molecular weight volatile organic aroma and flavor compounds from the food into the polymer, based on the sorption mechanism, has been and continues to be the subject of considerable attention and concern. Sorption may result in the loss of aroma and flavor volatiles associated with product quality. Anhydride-functionalized polymers modified with cyclodextrin effectively address problems related to poor organic barrier, surface hydrophobicity, and food flavor scalping over blends of conventional polyolefin. The compositions described herein is particularly useful for container articles constructed from laminates having a heat sealable internal food contact surface which enables significant flavor retention in fruit juices contained therein over the shelf life of the product.

In a properly designed food package, polymers should sorb a minimum amount of the critical flavorings while meeting all other performance requirements. Flavor loss due to sorption into the packaging polymer is generally assumed to be detrimental to product quality. In contrast, the fruit juice industry has designed liquid packaging to take advantage of sorption losses by striving to eliminate off-flavor precursors. The present disclosure relates to the use of the packaged food contact polymer layer, as illustrated by the juice example, to selectively remove undesirable off-flavors from the packaged foods while minimizing the loss of important flavoring compounds. A food package contact layer can be constructed of, for example, anhydride-functionalized polymers modified with cyclodextrin to effectively address problems related to poor organic aroma/flavor barrier, unwanted food flavor scalping, and removal of offensive odors/aromas from the interior of food packages produced by, for example, lipid oxidation, lipid hydrolysis, protein/amino acid breakdown, and like changes or reactions of the packaged food. These active packaging polymer improvements of the disclosure are significant compared to conventional polyolefins and can considerably improve food taste over the shelf-life term of the product.

Packaging laminates have been used for many years for packaging food products. A widely known and used container is a paperboard-based structure, which is coated with various barrier and sealant materials. The contact layer for the food package of the disclosure is heat sealable, thus providing a useful barrier structure for converting a stock material into cartons and similar food retaining packages which require heat sealing.

### Absorbent Articles

Absorbent articles for human or animal use of the present disclosure can include, for example, an incontinent under garment such an adult diaper, a sanitary napkin, a wipe sheet, a tissue sheet, absorbent underpants, training pants, an absorbent wipe, a tissue, an underarm shield, and like absorbent articles, or combinations thereof. In embodiments, depending upon the application, the absorbent article can absorb, for example, bodily fluids or excretions, such as blood, urine, pus, nasal mucus, and like fluids or excreta, and odors there from, in any of various absorbable forms, such as sprays, coatings, suspensions, dispersions, spills, leaks, and like absorbable targets. The absorbent articles can be used in human or animal care applications including, for example, sterile medical articles or processes, such as medical treatment including healing or disease prevention.

A medical article or medical article component of the disclosure can be, for example, a mask such as for the face or body, a garment or like apparel, a drape, a bandage, a wound dressing, a bedding material such as a disposable bed pad, a mattress cover, a pillow cover, and like articles, or combinations thereof.

A clothing article or clothing article component of the disclosure can be, for example, a garment, a chemically resistant garment, a hunting garment, a sports wear garment, a protective work garment, a garment liner, a garment accessory, a garment accessory liner, a foot wear liner, industrial workwear such as protective clothing and accessories, and like apparel articles, or combinations thereof. A garment accessory includes, for example, a hat, a scarf, a necktie, a glove, a mitten, a hanky, a handbag, a purse, a wallet, a watch band, a backpack, and any like accessory articles. A foot wear liner includes, for example, a shoe liner, a boot liner, a support liner, an insole insert, a sandal liner, and like articles.

A household article or household article component of the disclosure can be any article or article component that is useful in the home or like household or lodging environments, including hotels, inns, hospitals, furnished rental property, elder care housing, a dormitory, a restaurant, a dining hall, and like residential or institutional settings, for example, a bedding material, a mattress cover, a pillow cover, a furniture liner, a furniture cover, a table cloth, a seat cover, draperies, a wall covering, a carpet backing, a lunch pail liner, a refuse lid liner, a refuse container, a refuse container liner, and like articles or article components, or combinations thereof.

A pet care article or pet care article component of the disclosure can be, for example, a bedding material, a wipe or wipe sheet, a towel, a mat, a collar, a garment, a foot wear or paw wear liner, such as a “bootie” or sock which can be integral to or separable from a foot wear article, a cage liner, a hygiene article, and like articles, or combinations thereof. A pet care bedding material can include, for example, a mattress cover, mattress pad, pillow case, bed sheet, and like materials or articles. Other examples of a pet care article or pet care article component can include, for example, a garment liner, a garment accessory, a garment accessory liner, or combinations thereof.

### Sampling and Sample Preparation for Detection and Diagnostics

### ACTIVE SAMPLING

Swabs for Surfaces
Swabs for Clinical Matrices
Syringe Filters for Aqueous Matrices
In-line Filters for Waterborne
In-line Filters for Airborne
*

### PASSIVE SAMPLING

Aerosol Badges
*

### Capture and Clean for Disinfection

### CLINICAL/OFFICE—CLINIC-HOSPITAL

Surgical Masks
Drapes
BACTwipe™ for Surfaces Disinfection
surgical sponge

### INDUSTRIAL/FOOD PROCESSING

In-line Feedwater Treatment
BACTwipe™ for Surfaces Disinfection
*

### CONSUMER/HOUSEHOLD

In-line Tapwater Treatment
BACTwipe™ for Surfaces Disinfection
*

### CONSUMER/PERSONAL HYGIENE

Diapers
Tissues
Acne Wipes
Dental Floss
Disinfect Wipes
Bandages
*

### Antimicrobial Surfaces for Prevention (Direct Kill or No-Bind)

### CLINICAL/FOOD PROCESSING

Laminate Surfaces
Soft/Porous Materials
*

In embodiments, any of the abovementioned articles or components can be prepared or processed with any of the abovementioned processes or any of the following melt based processes to form a desired article or component structure, and combinations thereof, including: spunbond, meltblown, nanofiber, porous film, or co-form. In embodiments, any of the abovementioned articles or components can also be prepared or processed with any of the following staple-based or natural fiber based processes or structures, and combinations thereof, including: hydroentanglement, bonded-carded, needle punched, airlaid, wetlaid, and like processes and structures, or combinations thereof.

Bacterial contamination of surfaces is implicated as a contributor to food-borne illness from both home kitchens and food processing plants. In addition, surface contamination is a factor in the prevalence of hospital-associated infections. Levels of surface contamination have been found to vary greatly, with 1-1000 cfu/25 cm² in healthy office buildings, 100-1000 cfu/swab on apparently clean hospital surfaces, and 5-20,000 cfu/in² on various kitchen surfaces with most household surfaces less than 4,000 cfu/in². Most efforts to study surface decontamination have focused on the ability of disinfectant solutions to reduce bacterial growth on culture surfaces (i.e., zones of inhibition on agar plates). However, a few more recent studies have evaluated the ability of a disinfectant treated wipe to decontaminate surfaces. Shimura et. al. prepared contaminated glass surfaces (40×30 cm) with a 104 cfu/ml MRSA suspension and evaluated the ability of disinfectant-saturated microfiber wipes to decontaminate the surface. In a similar study, Williams et. al. used stainless steel discs as the substrate. However, the disc surfaces were contaminated with a much greater bacterial load (about 6-7 log cfu/2 cm diameter disc) then would be expected for a visually clean surface. In addition to a wipe's ability to physically remove the bacteria from a contaminated surface, a critical factor that contributes to surface contamination is the release of previously captured bacteria during the cleaning process, which spreads contamination “hot spots” over a larger surface area. In a hospital study, increased bacterial contamination of patients' environmental surfaces was found after cleaning due to the spread of bacteria during the cleaning process. Therefore, reducing the level of bacterial release and subsequent cross-contamination of surfaces is highly desirable in a cleaning wipe. The purpose of this study was to evaluate the efficacy of the modified microbial capture wipe substrate relative to unmodified substrate for:

1) the removal of Staphylococcus aureus from a model surface and

2) retention of captured bacteria by the wipe material.

The foregoing is applicable to various compositions and articles of the disclosure. The following examples and data further exemplify the technology. These examples are intended to be representative of specific embodiments, and are not intended as limiting. While the technology is susceptible to various modifications and alternative forms, specifics thereof have been shown by way of example and drawings, and will be described in detail. It should be understood, however, that the disclosure is not limited to the particular embodiments described. On the contrary, the intention is to cover modifications, equivalents, and alternatives falling within the spirit and scope of the concepts disclosed. As used herein, and in the claims, the term “comprising” is inclusive or open-ended and does not exclude additional unrecited elements, compositional components, or method steps. Accordingly, such term is intended to be synonymous with the words “has”, “have”, “having”, “includes”, “including”, and any derivatives of these words.

### EXPERIMENTAL SECTION

### Example 1

### Experimental

### Materials: Culture of Organisms

Names & ATCC numbers
   E. coli, ATCC 25922
   Staph aureus, ATCC 6538
   Salmonella enterica serovar Typhimirium, ATCC 14020
   Listeria monocytogenes, ATCC BAA751
Media
   LB broth—stock for testing
   LB agar—stock culture maintenance, all except Salmonella
   Hektoen Enteric Agar—stock culture maintenance, Salmonella
Plate counting
   Used to quantitate cultures prior to testing

Preparation of Non-Woven Starting Materials:
This study used Swiffer® brand nonwoven polyester pads (Swiffer Sweeper, central nonwoven pad). Washed pad(s) in 5× changes of tap and R/O water to remove added chemicals, e.g. perfume agents.

Reaction of Amine:
Nonwoven materials modified with a diamine (ethylene diamine, diethylenetriamine, tetraethylenepentamine) using a 10% (v/v) aqueous solution of the amine in sufficient volume to saturate and cover the nonwoven material. The expected reaction is cleavage of some of the polyester ester bonds to incorporate the amine reagent as an amide. The reaction was run at RT or approximately 60 C for periods up to several days. The amine modified nonwoven polyester material was worked-up from the reaction solution using multiple changes of R/O water at ca. 60° C. and RT. Ninhydrin based amine analysis of the material gave amine (both primary and secondary) loads of up to 15 nanomoles available amine per milligram of nonwoven material (dry weight). On a per area basis based on a 6 mm diameter disk that typically weighed 6 mg; 0.32 umoles per square cm).

Reaction of Capture Agent:
The amine modified material was further modified by the addition of Compound I:

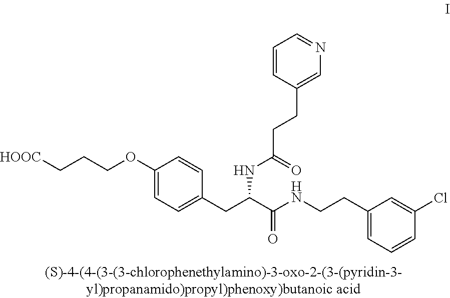

using the standard protocol:
a. Capture Agent
Compound I, (S)-4-(4-(3-(3-chlorophenethylamino)-3-oxo-2-(3-(pyridin-3-yl)propanamido)propyl)phenoxy)butanoic acid (Compound I) was synthesized as described in J. Am. Chem. Soc., 2009, 131 (46), pp 16660-16662. Compound I was dissolved in an 80/20 v/v solution of DMF/H₂O at 40 mmol/mL of aqueous DMF. Then sulfo-N-hydroxysuccinimide (SNHS) and 1-ethyl-3-(3-dimethylaminopropyl)carbodiimide (EDAC) was added to the aqueous DMF solution to form a reaction solution having a molar ratio of 1.6 SNHS:1.1 EDAC:1.0 Compound I. Then an amine modified fabric, as described in section a. above, was immersed in the reaction solution in an amount corresponding to 2 molar equivalents of Compound I per mole of available amine, wherein available amine was calculated in section a above. The fabric was agitated in the reaction solution overnight (about 16 hours) at laboratory temperature, followed by washing with aqueous ethanol solution and drying to give the filter media modified with Compound I.
Ninhydrin amine analysis of the fabric treated in this manner showed significant loss of both primary and secondary amine functionality when compared to the amine treated fabric (section a.), indicating that Compound I was covalently attached to amine moieties present on the fabric surface. The concentration of Compound I bonded to the amine functionality present on the fiber surface was greater than 25 mol %, usually greater than 40 mol %, and often greater than about 60 mol % of available amines as analyzed prior to the reaction with Compound I.

Bacteria Capture

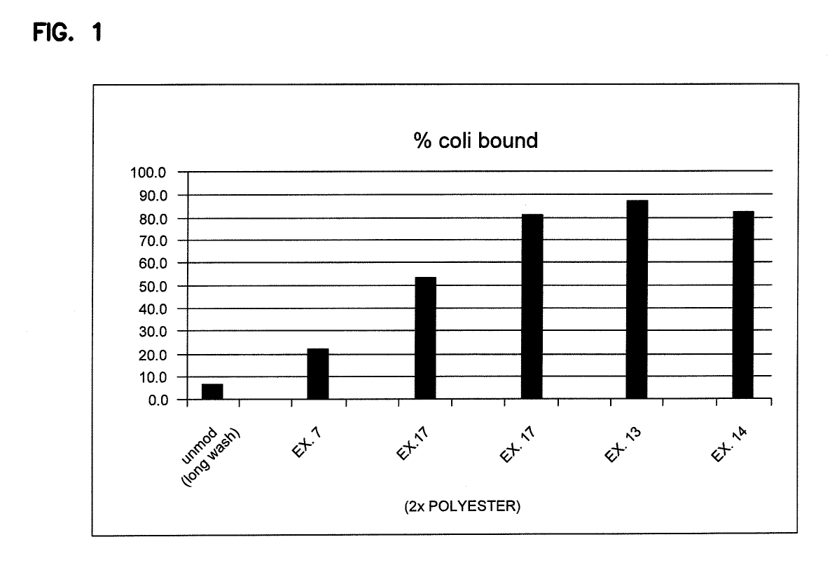

Wet Protocol
Cutting of discs
   6 mm diameter
   Approx 6 mg/disc
Add to solution of bacteria
   Disc hydrated in sterile water
   Water spiked with bacteria
   Allowed to equilibrate on rotator 5-15 minutes
Evaluation of binding
   Water sampled and plated for counting
   Plate counts incubated overnight at 37 C
   Counted and compared to controls (see FIG. 1)
Controls
   Bacterial control—bacterial suspension added to 500 ul sterile water without disc, allowed to equilibrate and sampled as above
   Washed Swiffer used as control
Results: FIG. 1 shows the results of E. coli testing at 1000 CFU/ml. Unmodified non-woven control materials bound less than 10% of challenge E. coli load and the modified non-woven materials removed between 50 and 90%.

Dry Protocol
Cutting of discs—same as above
Inoculation of discs
   30 ul of bacterial suspension pipetted directly onto disc
   Allowed to absorb 5 min
Sampling of unbound material
   Inoculated disc added to 500 ul sterile water
   Allowed to equilibrate on rotator 5 min
   Water sampled and plated for counting
Evaluation of binding
   Plate counts incubated overnight at 37 C
   Counted and compared to controls
Controls
   Bacterial control—30 ul bacterial suspension added to 500 ul sterile water, allowed to equilibrate and sampled as above
   Washed Swiffer used as [negative] control
Culture of discs
   In some experiments, inoculated disc removed from water and placed on agar, incubated overnight at 37 C
Results:

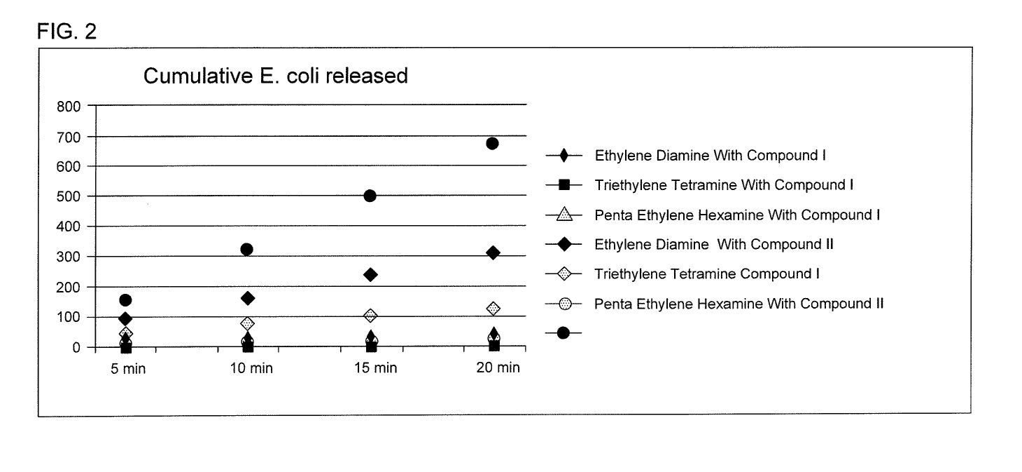

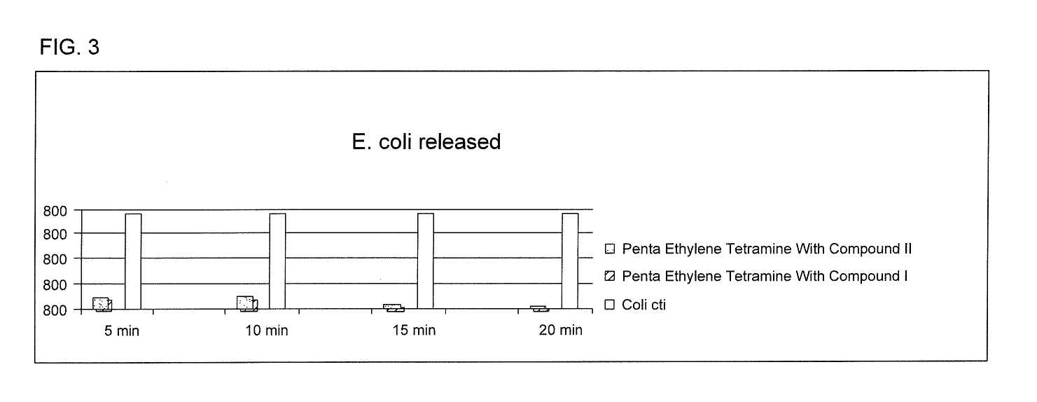

FIG. 2: Binding of E. coli, 1000 cfu/ml on capture group-modified surfaces. Coli control (water and bacteria, no wipe material) shows bacteria available in system. capture group materials compound I and compound II were created on various amine lawns (ED—ethylenediamine, Tri- diethylenetriamine, Penta-tetraethylenepentamine). Most efficient binding was demonstrated by Compound °I on Penta.

ure 3 shows favorable binding kinetics. Water sampled at multiple timepoints after inoculated disc inserted in water. Little or no release of bound bacteria was demonstrated over 20 minutes.

TABLE 4
The table shows that the amine modified materials are capable
of removing substantial quantities (% removal) of microorganisms
from a surface. Adding the compound I to the non-woven
significantly improves removal as shown.

| | Organism | | | |
|---|---|---|---|---|
| Material | E. coli | S. aureus | Salmonella | Listeria |
| Pentamine and | 99.8 | 97.2 | 62.5 | 97.6 |
| Compound I | | | | |
| Pentamine | 94. | 100 | 97.7 | 99.8 |

### Examples 2-9

### Preparation of Wipe

### Non-Woven and Woven Starting Materials:

### Polycellulose Source: Harmony Inc., Catalog T60512

### SpunLace Source: Valutek Inc., Catalog VTSNTR-1212

### Polyester 2× Source: Valutek Inc., Catalog VT2PNW

Materials used as received for chemical modification or washed with 3× changes of 25% Aq. methanol for use as unmodified controls.
Reagent materials: (sourced from Aldrich Chemical Co.)
Reaction of Starting Materials with Amine:
Nonwoven materials modified with
ethylene diamine (Ex. 2),
diethylene triamine (Ex. 3),
tetraethylene pentamine (Ex. 4),
succinic acid cross-linked tetraethylene pentamine (Ex. 5),
polyethylenimine (Mn 1,200, Mw 1,300) (Ex. 6),
polyethylenimine (Mn 10,000, Mw 25,000) using a 50% (v/v) aqueous solution of the amine or mixture of amines (tetraethylene pentamine:polyethylenimine (Mn 1,200, Mw 1,300) (90/10 (v/v) (Ex. 7);
tetraethylene pentamine:polyethylenimine (Mn 1,200, Mw 1,300), polyethylenimine (Mn 10,000, Mw 25,000) (90/10/1 (v/v/v)(Ex. 10) in sufficient volume to saturate and cover the nonwoven material. (Ex. 8).

The expected reaction with polyester or cellulose will occur with functional groups on the molecule or with groups that are created by energetic reaction conditions. The reaction was run using a 60 W microwave and three to nine 60 second microwave, 60 second cool down, 60 second microwave, 120 second cool down cycles. The amine modified nonwoven material was worked-up from the reaction solution using multiple changes of 25% Aq. methanol. Ninhydrin based amine analysis of the materials gave amine (both primary and secondary) loads of up to 100 nanomoles available amine per milligram of nonwoven material (dry weight).

### Example 9

### Quat Reaction of Amine with Dimethyl Sulfate

The amine modified material was further modified by reaction with excess dimethyl sulfate in Aq. ethanol/0.2 N Na₂CO₃ (1/1(v/v)) followed by work-up from the reaction solution using multiple changes of 25% Aq. methanol. Ninhydrin based amine analysis of the materials gave amine loads that were less than 30% of the amine only modified material indicating that up to 70% of the amines had been converted to quaternary salts.

### Examples 10-17

### Reaction Amine/Nonwoven with Capture Agents

### Starting Materials

The amine modified nonwovens of Ex, 7

Reaction of Capture Agent:

The amine modified material was further modified by the addition of Compounds I-V are as described above using the standard protocol:
b. Capture Agent
One or more of compound I-VI, synthesized as described in J. Am. Chem. Soc., 2009, 131 (46), pp 16660-16662 was dissolved in an 80/20 v/v solution of DMF/H₂O at 40 μmol/mL of aqueous DMF.

| Example | Compounds |
|---|---|
| 10 | I |
| 11 | II |
| 12 | III |
| 13 | IV |
| 14 | V |
| 15 | I + VI |
| 16 | I + III |

Then sulfo-N-hydroxysuccinimide (SNHS) and 1-ethyl-3-(3-dimethylaminopropyl)carbodiimide (EDAC) was added to the aqueous DMF solution to form a reaction solution having a molar ratio of 1.6 SNHS:1.1 EDAC:1.0 Compound. Then an amine modified fabric, as described in section a. above, was immersed in the reaction solution in an amount corresponding to 2 molar equivalents of Compound per mole of available amine, wherein available amine was calculated in section a. above. The fabric was agitated in the reaction solution overnight (about 16 hours) at laboratory temperature, followed by washing with aqueous ethanol solution and drying to give the filter media modified with Compound.
Ninhydrin amine analysis of the fabric treated in this manner showed significant loss of both primary and secondary amine functionality when compared to the amine treated fabric (section a.), indicating that Compound was covalently attached to amine moieties present on the fabric surface. The concentration of Compound bonded to the amine functionality present on the fiber surface was greater than 25 mol %, usually greater than 40 mol %, and often greater than about 60 mol % of available amines as analyzed prior to the reaction with Compound.

### Culture of Organisms

Names & ATCC numbers:
   Staphylococcus auerus, ATCC 6538
   Salmonella enterica serovar Typhimirium, ATCC 14020
   Pseudomonas aeruginosa, ATCC 27853
   Escherichia coli, ATCC 25922
Media
   BHI broth—used for initial enrichment of Culti-Loop lyophilized stocks
   TS broth/agar—stock culture maintenance, testing stocks, plate counting for Staph aureus, Pseudomonas
   LB broth/agar—stock culture maintenance, testing stocks, plate counting for E. coli, Salmonella
Plate counting
   Used to quantitatively evaluate performance of filter materials

This study used nonwoven wipe substrates modified as described. The wipe evaluation generally used the protocol described by Williams et. al (5). Briefly, the wipe material was attached to a 4 cm disc at the base of a rod to allow mechanical rotation by a stirring motor. A balance was used to measure the force applied between the wipe and the disc. Stainless steel discs (20 mm diameter, type Grade 2B finish), as specified in the Williams, et. al. protocol (5), were sourced from Discount Steel, Inc., Minneapolis, Minn. The discs were glued to small plastic caps for stability and ease of handling prior to inoculation.

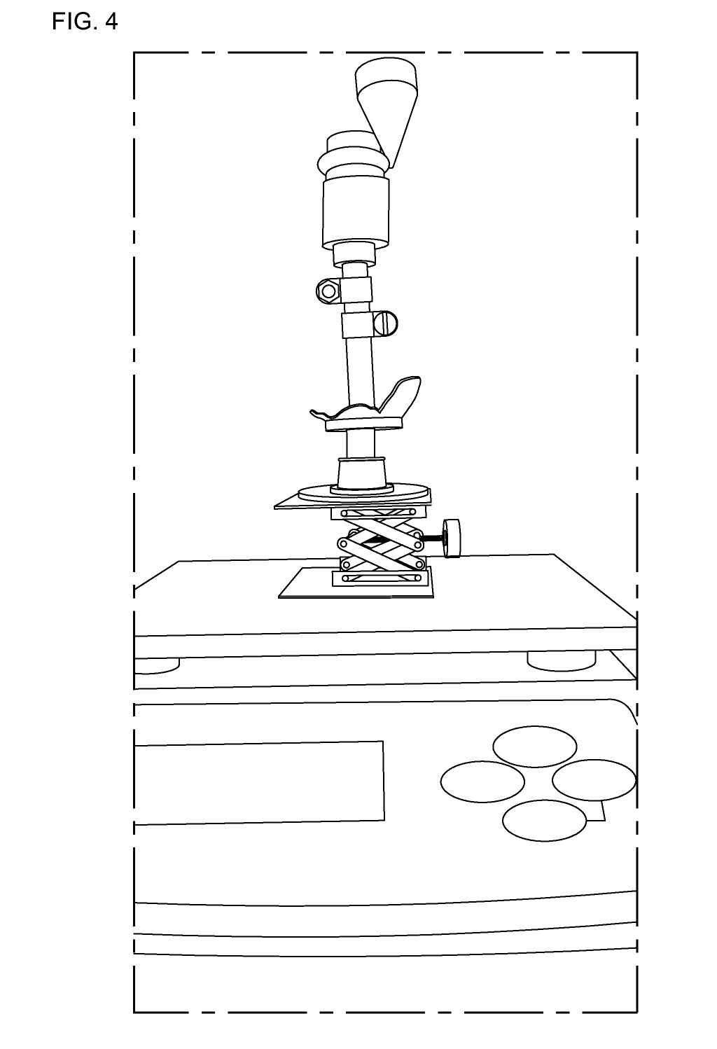

FIG. 4: The apparatus built for the wiping process was based on William's et. al. (5). The apparatus consisted of a motor and spindle to turn the wipe and a balance and mini-jack to lift the inoculated stainless steel disc into contact with the revolving wipe with the desired degree of contact force.

Wipe protocol: The protocol used was based on the test apparatus of Williams et. al. (5). A bacterial stock was diluted in 0.3 mg/ml BSA to achieve a suspension containing 2.81E03-1.91E04 cfu/20 ul inoculum. Stainless steel discs (2 cm diameter) were inoculated with 20 ul bacterial suspension and allowed to dry at 37 C for ˜25 minutes. Discs inoculated with E. coli and Pseudomonas were tested immediately after inoculation without drying in order to maintain organism viability for evaluation. Wipe material was fixed to the wiping apparatus and wetted with ˜2 mls sterile RO water by immersion for 5-10 seconds. The inoculated disc was wiped in the apparatus for 10 seconds at ˜130 rpm, pressure of 100 g+/−10 g. The wiped disc was placed in a 50 ml beaker containing ˜5 g glass beads and 5 mls of tryptone sodium chloride with surfactants (8.5 g/L NaCl, 1 g/L tryptone, 30 g/L saponin, 30 ml/L Polysorbate 80) and placed on a shaker at 150 rpm for 5 minutes. The used wipe was pressed onto agar plates up to eight times. Following adpression, the wipe was cut from the apparatus, placed in a glass vial containing 1-2 ml sterile RO water, and mixed on a shaker at 150 rpm for 5 minutes. The liquid from both the wiped disc and the used wipe was plated, incubated overnight at 37 C and the number of colonies manually counted. As a control, an unwiped inoculated disc was sprayed with sterile RO water and placed directly into neutralizer with beads and plated as above.

Table 5: Materials built on polycellulose substrate. Percentage of Staph aureus removed from disc after wiping (calculated from percentage remaining on disc) and percentage released by the used wipe (total of adpression and washing).

TABLE 5
Removal release characteristics

| | | % removed | % released |
|---|---|---|---|
| Example | Material | S. aureus | S. aureus |
| Comparative | polycellulose unmodified | 75 | 89.8 |
| 7 | tetraethylene | 100 | 0.8 |
| | pentamine:polyethylenimine | | |
| | (Mn 1,200, Mw 1,300) | | |
| 8 | tetraethylene | 97.7 | 1.9 |
| | pentamine:polyethylenimine | | |
| | (Mn 1,200, Mw 1,300), | | |
| | polyethylenimine (Mn | | |
| | 10,000, Mw 25,000) | | |
| 10 | tetraethylene | 100 | 24.5 |
| | pentamine:polyethylenimine | | |
| | (Mn 1,200, Mw 1,300) + | | |
| | Compound I | | |
| 15 | tetraethylene | 98.7 | 3.4 |
| | pentamine:polyethylenimine | | |
| | (Mn 1,200, Mw 1,300) + | | |
| | Compound I + Compound | | |
| | VI | | |
| 16 | tetraethylene | 94.9 | 9.9 |
| | pentamine:polyethylenimine | | |
| | (Mn 1,200, Mw 1,300) + | | |
| | Compound I + Compound | | |
| | III | | |
| 10 | tetraethylene | 99 | 4.2 |
| | pentamine:polyethylenimine | | |
| | (Mn 1,200, Mw 1,300) | | |
| | reacted to form quarternary | | |
| | salt | | |

Table 6: Materials built on spunlace substrate. Percentage of Staph aureus removed from disc after wiping (calculated from percentage remaining on disc) and percentage released by the used wipe (total of adpression and washing).

TABLE 6
Removal release characteristics

| | | % removed | % released |
|---|---|---|---|
| Example | Material | S. aureus | S. aureus |
| | spunlace unmodified | 87.7 | 43.8 |
| 7 | tetraethylene | 98.2 | 0.7 |
| | pentamine:polyethylenimine | | |
| | (Mn 1,200, Mw 1,300) | | |
| 8 | tetraethylene | 97.5 | 1.0 |
| | pentamine:polyethylenimine | | |
| | (Mn 1,200, Mw 1,300), | | |
| | polyethylenimine (Mn | | |
| | 10,000, Mw 25,000) | | |
| 10 | tetraethylene | 100 | 14.6 |
| | pentamine:polyethylenimine | | |
| | (Mn 1,200, Mw 1,300) + | | |
| | Compound I | | |
| 15 | tetraethylene | 97.1 | 13.0 |
| | pentamine:polyethylenimine | | |
| | (Mn 1,200, Mw 1,300) + | | |
| | Compound I + Compound | | |
| | VI | | |
| 16 | tetraethylene | 99.3 | 35.5 |
| | pentamine:polyethylenimine | | |
| | (Mn 1,200, Mw 1,300) + | | |
| | Compound I + Compound | | |
| | III | | |
| 10 | tetraethylene | 99.6 | 26.1 |
| | pentamine:polyethylenimine | | |
| | (Mn 1,200, Mw 1,300) | | |
| | reacted to form quarternary | | |
| | salt | | |

TABLE 7
Materials built on 2x polyester substrate. Percentage of Staph aureus
removed from disc after wiping (calculated from percentage
remaining on disc) and percentage released by the used wipe
(total of adpression and washing).

| | | % removed | % released |
|---|---|---|---|
| Example | Material | S. aureus | S. aureus |
| unmodified | 2X polyester unmodified | 93 | 17.2 |
| | tetraethylene | 98.5 | 0.2 |
| | pentamine:polyethylenimine | | |
| | (Mn 1,200, Mw 1,300) | | |

The test wipe materials were used to clean a stainless steel disc that had been inoculated with Staphylococcus aureus. The wiped disc was tested to determine the number of bacteria remaining on the disc surface, and used wipe was evaluated for bacteria released from the wipe. As shown in Tables 5-7, both the unmodified substrate and the modified wipe materials were effective in removing bacteria from the surface. This result is presumably due to the desirable mechanical “scrubbing” action of the wipe material, which is maintained through the modification process. The results indicate that the modified wipe material released significantly less bacteria relative to the unmodified wipe material.

TABLE 8
Comparison of unmodified polycellulose to modified polycellulose,
capture and retention of various microorganisms.

| | | | tetraethylene |
|---|---|---|---|
| | | | pentamine: |
| | | | polyethylenimine |
| | Removal/Release | polycellulose | (Mn 1,200, Mw |
| Organism | Charateristic | unmodified | 1,300) |
| Staph | % removed | 75 | 100 |
| | % released | 89.8 | 0.8 |
| Salmonella | % removed | 100 | 99 |
| | % released | 46.7 | 4.1 |
| Pseudomonas | % removed | 99.4 | 99.2 |
| | % released | 20.4 | 1.9 |
| E. coli | % removed | 93 | 99.4 |
| | % released | 31.3 | 0.5 |

The test wipe materials were used to clean a stainless steel disc that had been inoculated with various microorganisms. The wiped disc was tested to determine the number of bacteria remaining on the disc surface, and used wipe was evaluated for bacteria released from the wipe. As shown in Table 8, both the unmodified substrate and the modified wipe materials were effective in removing bacteria from the surface. The results indicate that the modified wipe material released significantly less bacteria relative to the unmodified wipe material against all microorganisms tested.

Plate CFU counts used to evaluate the release of bacteria from the wipe materials. Unmodified wipe substrate releases significant numbers of bacteria; greater than ninety percent (>90%) relative to the starting inoculum on the stainless steel discs. The remaining three of the modified wipes released very few of the captured bacteria. These results: (1) demonstrate the efficient mechanical removal of surface bacteria by both unmodified and modified wipe material and (2) retention of the wipe removed bacteria is significantly better with the modified material.

The following table highlights the advantages of the disclosed materials when compared to the most common commercial type of antimicrobial wipe.

Comparison Table 9

| | | |
|---|---|---|
| Composition | Commercial Wipe with | Wipe according to |
| | 0.29% | Example 7 or 10 |
| | Alky benzyl Quaternary | |
| | Compound and with 4% | |
| | isopropanol | |
| Use in surface | Home @ | 10 seconds wet contact |
| disinfection | 30 second contact time | |
| | Commercial @ | |
| | 240 second contact time | |
| Cross contamination | Initial microbial loading | Initial microbial loading |
| properties | remaining 0.0% | remaining 0.0%/1.8%% |
| | Pressed from Wipe 0.8% | Pressed from Wipe |
| | Washed from wipe 4.8% | 0.8%/0.7% |
| | | Washed from wipe |
| | | 0.0%/0.0% |
| Surface residue | Quat disinfectant | Capture components |
| | (dispersed in the residue | (covalently bound to |
| | non-woven) remains | non-woven) no residue |
| | after treatment | |
| Application | 30 to 600 seconds-wet | 10 seconds wet contact |
| characteristic | contact time | time (S. aureus) |

While the various modifications and alternative forms, specifics thereof have been shown by way of example and drawings, and will be described in detail. It should be understood, however, that the claims are not limited to the particular embodiments described. On the contrary, the intention is to cover modifications, equivalents, and alternatives falling within the spirit and scope of the disclose technology.

We claim:

1. An article comprising fiber, the article capable of removing a target organism from a surface, the article comprising:
(i) a collection of fiber; and
(ii) the fiber having pendent groups comprising:
(a) an organic capture agent bonded to and pendant on the fiber, the organic capture agent capable of binding to the target organism, the organic capture agent being present on the fiber in an amount of 0.01 to 80 mg-gm⁻¹ of fiber; and
(b) a polyamine group bonded to and pendant on the fiber, the polyamine group capable of binding to the target organism, the polyamine group being present on the fiber in an amount of 0.01 to 80 mg-gm⁻¹ of fiber;
wherein the article comprises at least about 0.1 gram to 1.0 kilograms] of fiber and the article is capable of removing a challenge population of target organisms to a degree that the surface is substantially non-infective.

2. The article of claim 1 wherein the surface is substantially noninfective when at least about 90% of a challenge population of target organism is removed.

3. The article of claim 1 wherein the article comprising a loose collection of fiber or fiber bat.

4. The article of claim 1 comprising melt blown fiber comprising a polyamide, a polyurethane a polycarbonate or mixtures thereof.

5. The article of claim 1 wherein the article comprising a woven fabric or nonwoven fabric.

6. The article of claim 1 wherein the fiber comprises a synthetic polyolefin fiber.

7. The article of claim 1 wherein the fiber comprises a cellulosic fiber, a synthetic polymeric fiber or a mixed cellulosic and synthetic polymeric fiber

8. The article of claim 1 wherein the fiber comprises a synthetic polyester fiber.

9. The article of claim 1 wherein the organic capture agent comprises compound I-VI as follows:

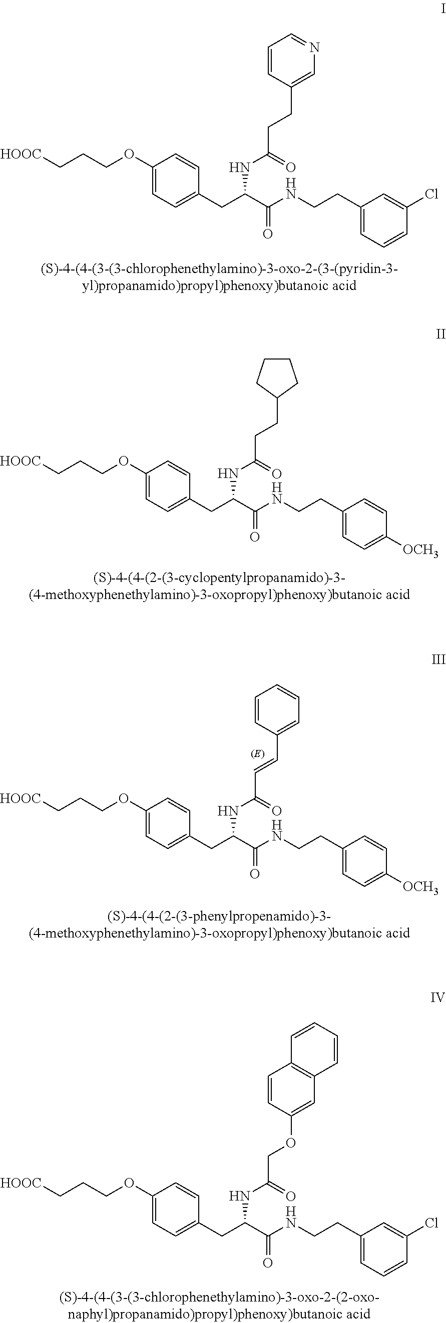

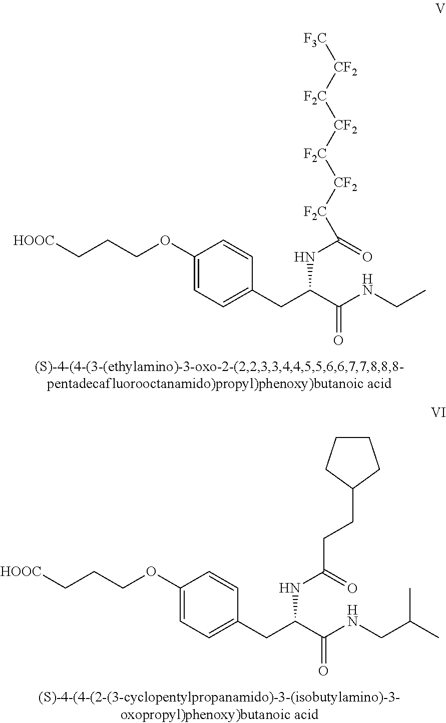

10. The article of claim 1 wherein the polyamine group comprises a compound of the formula:
NH₂—[(CH)₂)ₙ—NH—]ₘ—H;
wherein n is 2 to 4 and m is 1 to 4.

11. The article of claim 1 wherein the polyamine group comprises tetraethylene pentamine.

12. The article of claim 1 wherein the target organism comprises a population comprising a G+ or G− bacterium, a fungus, a virus, or a prion.

13. The article of claim 12 wherein the population comprises staphlococcus, coliform, campylobacter, salmonella or lysteria bacteria or mixtures thereof.

14. The article of claim 12 wherein the population comprises MRSA.

15. The article of claim 12 wherein the population comprises HIV, herpes, rhinovirus or combinations thereof.

16. A nonwoven article comprising fiber, the article capable of removing a target organism from a surface, the article comprising:
(i) a nonwoven fabric comprising the fiber; and
(ii) the fabric having pendent groups comprising:
an organic capture agent bonded to and pendant on the fiber, the organic capture agent capable of binding to the target organism, the organic capture agent being present on the fiber in an amount of 0.05 to 5 mg-cm⁻² of fiber;
wherein the article comprises at least about 0.1 to 80 grams of fiber and the article is capable of removing at least about 90% of a challenge population comprising the target microorganism.

17. The article of claim 16 wherein the fiber comprises a cellulosic fiber, a synthetic polymeric fiber or a mixed cellulosic and synthetic polymeric fiber

18. The article of claim 16 wherein the fiber comprises a synthetic polyolefin fiber.

19. The article of claim 16 wherein the fiber comprises melt blown fiber comprising a polyamide, a polyurethane a polycarbonate or mixtures thereof.

20. The article of claim 16 wherein the organic capture agent comprises compound I-V as follows:

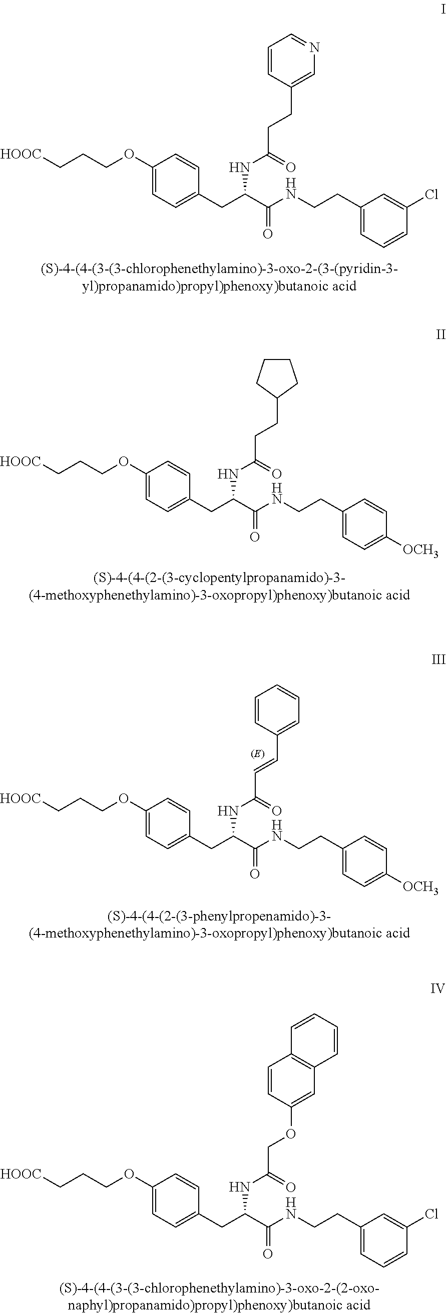

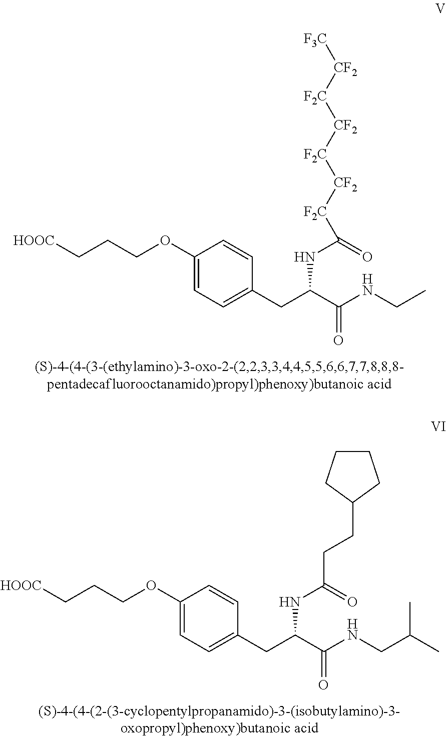

21. The article of claim 16 wherein the target organism comprises a population comprising a G+ or G− bacterium, a fungus, a virus, or a prion.

22. The article of claim 21 wherein the target organism comprises staphlococcus, coliform, campylobacter, salmonella or lysteria bacteria or mixtures thereof.

23. The article of claim 16 wherein the population comprises MRSA.

24. The article of claim 16 wherein the population comprises HIV, herpes, rhinovirus or combinations thereof.

25. A nonwoven article comprising fiber, the article capable of removing an target organism from a surface, the article comprising:
(i) a nonwoven fabric; and
(ii) the fabric having pendent groups comprising a polyamine group bonded to and pendant on the fiber, the polyamine group capable of binding to the target organism, the polyamine group comprising:
NH₂—[(CH)₂)ₙ—NH—]ₘ—H wherein n is 2 to 4 and m is 1 to 4;
the polyamine being present on the fiber in an amount of 0.05 to 80 mg-cm⁻² of nonwoven; wherein the article comprises at least about 0.1 to 50 grams of fiber and the article is capable of removing at least about 90% of a challenge population of target microorganism.

26. The article of claim 25 wherein the polyamine comprises tetraethylene pentamine.

27. The article of claim 25 wherein the fiber comprises a cellulosic fiber, a synthetic polymeric fiber or a mixed cellulosic and synthetic polymeric fiber

28. The article of claim 25 wherein the fiber comprises a synthetic polyolefin fiber.

29. The article of claim 28 wherein the fiber comprises a synthetic polyester fiber.

30. The article of claim 25 wherein the polyamine group comprises tetraethylene pentamine.

31. The article of claim 25 wherein the target organism comprises a population comprising a G+ or G− bacterium, a fungus, a virus, or a prion.

32. The article of claim 31 wherein the target organism comprises staphlococcus, coliform, campylobacter, salmonella or lysteria bacteria or mixtures thereof.

33. The article of claim 31 wherein the population comprises MRSA.

34. The article of claim 31 wherein the population comprises HIV, herpes, rhinovirus or combinations thereof.

35. A nonwoven article comprising fiber, the article capable of removing a target organism from a surface, the article comprising:
(i) a nonwoven fabric; and
(ii) the fabric having pendent groups comprising:
(a) an organic capture agent bonded to and pendant on the fiber, the organic capture agent capable of binding to the target organism, the organic capture agent being present on the fiber in an amount of 0.01 to 80 mg-cm⁻² of fiber; and
(b) a polyamine group bonded to and pendant on the fiber, the polyamine group capable of binding to the target organism, the polyamine group being present on the fiber in an amount of 0.01 to 2 mg-cm⁻² of fiber;
wherein the article comprises at least about 0.1 to 100 grams of fiber and the article is capable of removing a challenge population of the target organisms to a degree that the surface is substantially non-infective.

36. The article of claim 35 wherein the surface is substantially noninfective when at least about 90% of a challenge population of target organism is removed.

37. The article of claim 35 wherein the fiber comprises a cellulosic fiber, a synthetic polymeric fiber or a mixed cellulosic and synthetic polymeric fiber

38. The article of claim 35 wherein the fiber comprises a synthetic polyolefin fiber.

39. The article of claim 35 wherein the fiber comprises melt blown fiber comprising a polyamide, a polyurethane a polycarbonate or mixtures thereof.

40. The article of claim 35 wherein the organic capture agent comprises compound I-V as follows:

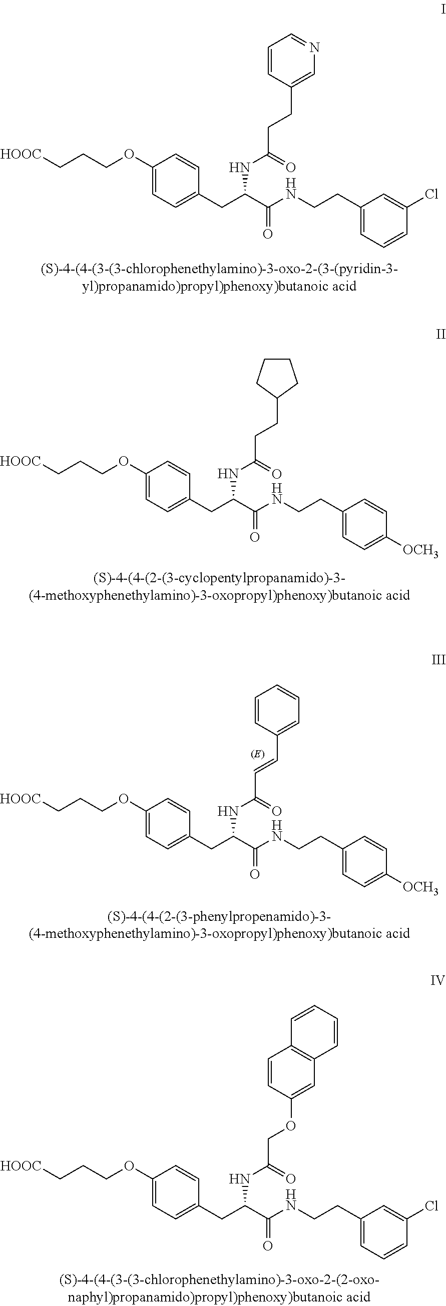

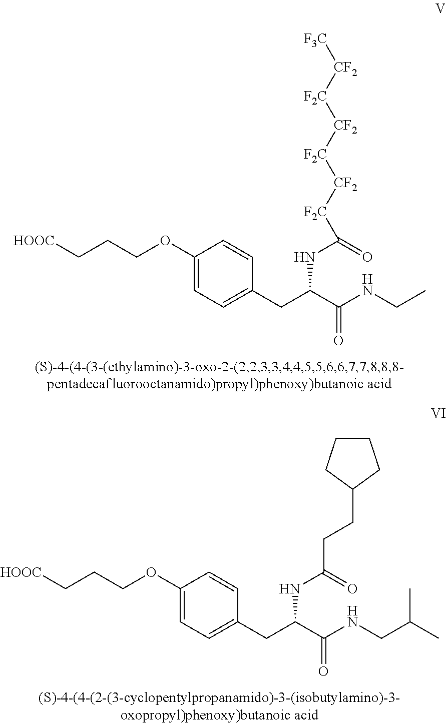

41. The article of claim 35 wherein the polyamine group comprises a compound of the formula:
NH₂—[(CH)₂)ₙ—NH—]ₘ—H;
wherein n is 2 to 4 and m is 1 to 4.

42. The article of claim 35 wherein the polyamine group comprises tetraethylene pentamine.

43. The article of claim 35 wherein the target organism comprises a population comprising a G+ or G− bacterium, a fungus, a virus, or a prion.

44. The article of claim 35 wherein the population comprises staphlococcus, coliform, campylobacter, salmonella or lysteria bacteria or mixtures thereof.

45. The article of claim 35 wherein the population comprises MRSA.

46. The article of claim 35 wherein the population comprises HIV, herpes, rhinovirus or combinations thereof.

47. The article of claims 36 to 46 wherein the article comprises a flexible wipe.

48. A method of removing infective units of a target organism from a surface, the method comprising contacting a surface containing from about 1 to 10⁸ infective units per square centimeter of surface with the article of claim 1, 16, 25 or 35 in such a fashion that substantially all of the contaminated surface is contacted with the article and the surface is left with less than one infective unit per 1,000 units originally present on the surface

49. The method of claim 48 wherein the surface is in a medical facility.

50. The method of claim 48 wherein the surface is in a domestic residence.

51. The method of claim 48 wherein the surface is in a food preparation facility.

52. An article comprising fiber, the article capable of removing a target organism from a surface, the article comprising:
(i) a collection of fiber; and
(ii) the fiber having pendent groups comprising an organic removal unit bonded to and pendant on the fiber, the organic capture agent capable of binding to the target organism, the organic capture agent being present on the fiber in an amount of 0.01 to 80 to mg-gm⁻¹ of fiber; wherein the article comprises at least about 0.1 gm to 1.0 kilograms of fiber and the article is capable of removing a challenge population of target organisms to a degree that the surface is substantially non-infective.

53. The article of claim 52 wherein the surface is substantially noninfective when at least about 90% of a challenge population of target organism is removed.

54. The article of claim 52 wherein the article comprising a loose collection of fiber or fiber bat.

55. The article of claim 52 comprising melt blown fiber comprising a polyamide, a polyurethane a polycarbonate or mixtures thereof.

56. The article of claim 52 wherein the article comprising a woven fabric or nonwoven fabric.

57. The article of claim 52 wherein the fiber comprises a synthetic polyolefin fiber.

58. The article of claim 52 wherein the fiber comprises a cellulosic fiber, a synthetic polymeric fiber or a mixed cellulosic and synthetic polymeric fiber

59. The article of claim 52 wherein the fiber comprises a synthetic polyester fiber.

60. The article of claim 52 wherein the organic capture agent comprises one of compound I-V as follows:

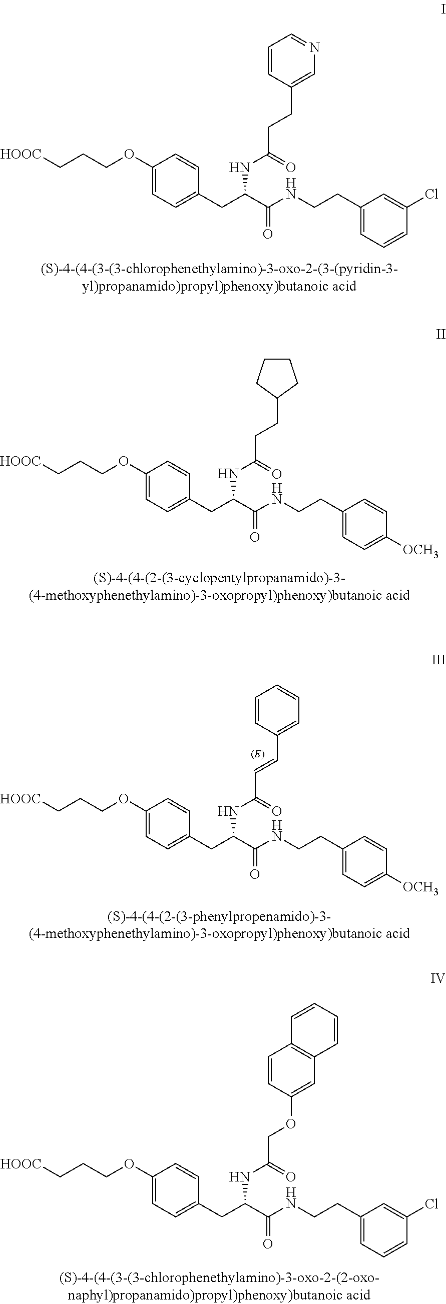

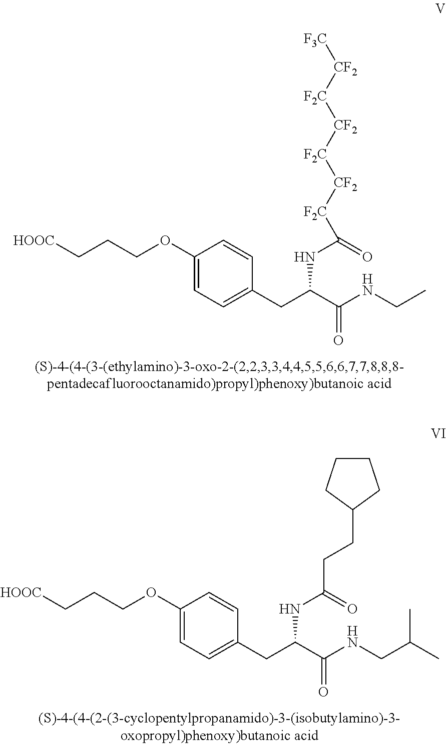

61. The article of claim 52 additionally comprising an amine.

62. The article of claim 52 wherein the amine comprises a polyamine group bonded to and pendant on the fiber, the polyamine group capable of binding to the target organism, the polyamine group being present on the fiber in an amount of 0.01 to 80 mg-gm⁻¹ of fiber.

63. The article of claim 52 wherein the polyamine group comprises a compound of the formula:
NH₂—[(CH)₂)ₙ—NH—]ₘ—H; wherein n is 2 to 4 and m is 1 to 4.

64. The article of claim 52 wherein the polyamine group comprises tetraethylene pentamine.

65. The article of claim 52 wherein the target organism comprises a population comprising a G+ or G− bacterium, a fungus, a virus, or a prion.

66. The article of claim 65 wherein the population comprises staphlococcus, coliform, campylobacter, salmonella or lysteria bacteria or mixtures thereof.

67. The article of claim 65 wherein the population comprises MRSA.

68. The article of claim 65 wherein the population comprises HIV, herpes, rhinovirus or combinations thereof.
